(19) United States
(12) Patent Application Publication
(10) Pub. No.: US 2006/0257537 A1
(43) Pub. Date: Nov. 16, 2006

(54) METHOD TO REDUCE PINK COLOR IN LIGHT COLORED, COOKED, UNCURED MEATS

(75) Inventors: James R. Claus, Verona, WI (US); Lauren M. Sammel, Madison, WI (US)

Correspondence Address: GODFREY & KAHN, S.C., 780 N. WATER STREET, MILWAUKEE, WI, 53202, US

(73) Assignee: Wisconsin Alumni Research Foundation, Madison, WI (US)

(21) Appl. No.: 11/380,561

(22) Filed: Apr. 27, 2006

Related U.S. Application Data
(60) Provisional application No. 60/594,666, filed on Apr. 27, 2005.

(51) Int. Cl. A23L 1/277

(52) U.S. Cl. 426/253

(57) ABSTRACT

The present invention generally provides methods, compounds and techniques for reducing pink color in light colored meats. In one preferred embodiment, the present invention provides a method of reducing pink color in a light colored meat, comprising the step of contacting the meat with a compound selected from the group consisting of calcium chloride, tricalcium phosphate, sodium tripolyphosphate, lactoferrin, annatto, and combinations thereof, such that the pink color is reduced in the light colored meat.

### RELATED APPLICATION

The present invention seeks priority from U.S. Provisional Application No. 60/594,666 filed on Apr. 27, 2005, which is incorporated by reference, as if fully set forth herein for all purposes.

### STATEMENT REGARDING FEDERAL FUNDING

The present invention was supported in part by USDA/CSREES grant 02-CRHF-0-6055. The government of United States may have certain rights in this invention.

### TECHNICAL BACKGROUND

The present invention generally relates to meat processing and specifically relates to reducing pink color in light colored, cooked, uncured meats, such as in poultry, pork and other light colored meats.

### BACKGROUND OF THE INVENTION

Appearance, specifically color, is a primary factor by which consumers judge the quality, safety, and purchase of their meat. The concentrations and chemical states of heme pigments, including myoglobin, hemoglobin, and cytochrome c are predominately responsible for the color of meat. However, heme pigment concentrations and chemical states are variable due to intrinsic (pH, animal, age, diet, etc.) factors of meat systems as well as extrinsic (animal transport, pre- and post-harvest treatments, cooking, storage, etc.) factors, which may lead to undesirable color defects. One such defect is the pink color defect in cooked poultry and light colored meats such as uncured turkey, which sporadically occurs to give it a pink undercooked appearance even though it has been heat processed to ensure microbial destruction. The resulting pink cooked color contributes to perceived consumer safety concerns often leading to product rejection or discounting to encourage purchase.

The causes of the pink color defect in uncured cooked poultry or other light colored meat are diverse and stem from different conditions during live bird handling, harvest, and processing including but not limited to, high levels of nitrite and nitrate in feed, water or meat, stressing birds at harvest, gas (carbon monoxide, nitric oxide, nitrogen dioxide) exposure to live birds through exhaust fumes or exposure to meat during cooking, cooking temperatures, and storage. These factors can result in poultry meat with high pH, high reducing conditions, high levels of undenatured pigments, high levels of reduced hemochromes and nitrosylhemochrome, all of which may result in the pink color defect. Further, irradiation intended to ensure food safety, results in a persistent pink color related to the formation of carbon monoxide myoglobin. The various causes of the pink color defect make it difficult to implement a strategy to prevent its occurrence. Therefore, researchers have attempted to find ingredients that can be incorporated in turkey and other light colored meats at the processing level to inhibit pinked cooked color regardless of the causative factor present in the meat.

Ingredients, approved for use in meat products, previously shown to reduce the pink color defect in cooked ground turkey include citric acid, nonfat dried milk, and whey protein concentrates. However, these ingredients do not come without fault. Inclusion of citric acid in ground turkey lowers pH and cooking yields and therefore is not likely to be used by processors. Sodium citrate is the salt form of citric acid and may possess the same inhibitory properties to the pink color defect as citric acid. Although the mechanism by which citric acid reduces the pink color defect is unknown, it is conceivably related to its metal chelation properties. A better understanding of citric acid or sodium citrate's functionality may help in determining the optimum method for preventing pink cooked color regardless of the cause.

Although some whey protein concentrates reduce the pink color defect in uncured cooked ground turkey, some may actually increase pink cooked color. Whey protein concentrates are a by-product of cheese manufacturing and as a result are variable due to whey source and processing conditions. Further, whey protein concentrates consist of numerous components, which may or may not influence cooked meat color. Therefore, identifying the constituent in whey protein concentrates that reduces pink cooked color may represent a more viable option to consistently inhibit the pink color defect.

Accordingly, the need exists for solving the pink color problem, which will not only reduce financial losses to the poultry and light colored meat industry from discounted or unsold product, but will also increase the use of irradiation and subsequently the safety of poultry products and other light colored meats.

### BRIEF DESCRIPTION OF THE DRAWINGS

FIG. 1 depicts images of two treatments, one treatment did not have CaCl₂ (None) and the second treatment had 480 ppm CaCl₂ (CaCl₂). As depicted, CaCl₂ reduced the pink hue to a perceptible level in intact turkey breast.

FIG. 2 depicts sample of intact samples, including control samples and samples having citric acid (CA) 0.15% and 0.3% and sodium citrate (SC) 0.5% and 1.0%, which have irradiated at 0 kGy, 2.5 kGy and 5.0 kGy (kilogray). The control samples that were irradiated were visibly pink whereas samples containing CA and SC were less red and similar in color or lighter than the non-irradiated samples.

### SUMMARY OF THE INVENTION

The present invention generally provides methods, compounds and techniques for reducing pink color in light colored meats.

In a preferred embodiment, the present invention provides a method of reducing pink color in a cooked light colored meat, comprising the step of contacting the uncooked light colored meat with a compound selected from the group consisting of calcium chloride, tricalcium phosphate, sodium tripolyphosphate, lactoferrin, annatto, and combinations thereof, such that the pink color is reduced when the uncooked light colored meat is cooked. In a preferred embodiment, the uncooked meat is further contacted with sodium citrate. Generally, addition of a compound from the group above preferably does not substantially affect the cooking yield or pH of the cooked meat. Also, in this method, the uncooked meat may contain sodium nitrite or nicotinamide. Further, in the method the uncooked meat is poultry or pork, and most preferably, the uncooked meat is turkey. Most preferably the turkey is ground turkey or intact turkey breast.

In a preferred embodiment, the uncooked meat is contacted with the combination of compounds including calcium, citrate and phosphate ions and in another preferred embodiment, the uncooked meat is contacted with calcium chloride in the presence of phosphate ions.

Yet another embodiment of the present invention provides a method of reducing pink color in a cooked light colored ground or intact meat. This method also comprises the step of contacting the uncooked light colored ground or intact meat with a compound selected from the group consisting of calcium chloride, tricalcium phosphate, sodium tripolyphosphate, lactoferrin, annatto, and combination thereof, such that the pink color is reduced when the uncooked light colored intact or ground meat is cooked.

As discussed above, in this embodiment, the uncooked meat is further contacted with sodium citrate. Preferably, the cooking yield or pH of the cooked meat is substantially unaffected by addition of these compounds.

Generally, the uncooked meat may contain sodium nitrite or nicotinamide. In one embodiment, the uncooked meat is poultry or pork. In a preferred embodiment, the uncooked meat is ground turkey or intact turkey breast. In another preferred embodiment, the uncooked meat may be contacted with the combination of compounds including calcium, citrate and phosphate ions. In yet another preferred embodiment, the uncooked meat is contacted with calcium chloride in the presence of phosphate ions.

The invention also teaches a method of reducing pink color in a cooked light colored meat, comprising the steps of: (i) contacting an uncooked light colored meat with a compound selected from the group consisting of calcium chloride, tricalcium phosphate, sodium tripolyphosphate, lactoferrin, annatto, and combinations thereof; (ii) irradiating the uncooked light colored meat from step (i); and (iii) cooking the irradiated uncooked light colored meat from step (ii), such that the pink color is reduced when the irradiated uncooked light colored meat is cooked. In this method, the uncooked meat is further contacted with sodium citrate. Further as described in this method, the uncooked meat is poultry or pork.

Other objects and advantages of the present invention will be apparent from the detailed description, drawings and claims accompanying the specification.

### THE INVENTION

### I. GENERAL

Before the present methods are described, it is understood that this invention is not limited to the particular methodology, protocols, compounds, and reagents described, as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, and “having” can be used interchangeably.

As defined herein, “contacting” means that the compounds used in the present invention are introduced into a sample containing the light colored meat having a receptor in a test tube, flask, tissue culture, chip, array, plate, microplate, capillary, or the like, and incubated at a temperature and time sufficient to permit binding of the compound to the receptor. Methods for contacting the samples with the compound or other specific binding components are known to those skilled in the art and may be selected depending on the type of protocol to be run. Incubation methods are also standard and are known to those skilled in the art. “Contacting” further includes injecting a sample of the light colored meat or marinating the meat by means well established in the art with a compound of the present invention.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference for the purpose of describing and disclosing the chemicals, cell lines, vectors, animals, instruments, statistical analysis and methodologies which are reported in the publications which might be used in connection with the invention. Nothing herein is to be construed as an admission that the invention is not entitled to antedate such disclosure by virtue of prior invention.

### II. DETAILED DESCRIPTION OF PREFERRED EMBODIMENTS

The present invention generally provides methods, compounds and techniques for reducing pink color in light colored meats.

In a preferred embodiment, the present invention provides a method of reducing pink color in a cooked light colored meat, comprising the step of contacting an uncooked meat with a compound selected from the group consisting of calcium chloride, tricalcium phosphate, sodium tripolyphosphate, lactoferrin, annatto, and combinations thereof, such that the pink color is reduced when the uncooked light colored meat is cooked. In a preferred embodiment, the uncooked meat is further contacted with sodium citrate. Generally, the addition of a compound from the group above does not substantially affect the cooking yield or pH of the cooked meat. Also, in this method, the uncooked meat may contain sodium nitrite or nicotinamide. Further, in the method the uncooked meat is poultry or pork, and most preferably, the uncooked meat is turkey. Most preferably the turkey is ground turkey or intact turkey breast.

In a preferred embodiment, the uncooked meat is contacted with the combination of compounds including calcium, citrate and phosphate ions and in another preferred embodiment, the uncooked meat is contacted with calcium chloride in the presence of phosphate ions.

Yet another embodiment of the present invention provides a method of reducing pink color in a cooked light colored ground or intact meat. This method also comprises the step of contacting the uncooked light colored ground or intact meat with a compound selected from the group consisting of calcium chloride, tricalcium phosphate, sodium tripolyphosphate, lactoferrin, annatto, and combination thereof, such that the pink color is reduced when the uncooked light colored ground or intact meat is cooked.

As discussed above, in this embodiment, the uncooked meat is further contacted with sodium citrate. Preferably, the cooking yield or pH of the cooked meat is substantially unaffected by addition of these compounds.

Generally, in this embodiment, the uncooked meat may contain sodium nitrite or nicotinamide. In one embodiment, the uncooked meat is poultry or pork. In a preferred embodiment, the uncooked meat is ground turkey or intact turkey breast. In another preferred embodiment, the uncooked meat may be contacted with the combination of compounds including calcium, citrate and phosphate ions. In yet another preferred embodiment, the uncooked meat is contacted with calcium chloride in the presence of phosphate ions.

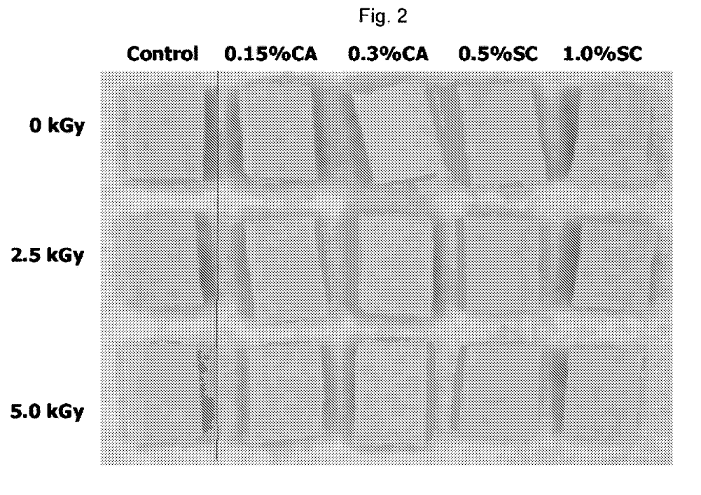

The invention also teaches a method of reducing pink color in a cooked light colored meat, comprising the steps of: (i) contacting an uncooked light colored meat with a compound selected from the group consisting of calcium chloride, tricalcium phosphate, sodium tripolyphosphate, lactoferrin, annatto, and combinations thereof; (ii) irradiating the uncooked light colored meat from step (i); and (iii) cooking the irradiated uncooked light colored meat from step (ii), such that the pink color is reduced when the irradiated uncooked light colored meat is cooked. In this method, the uncooked meat is further contacted with sodium citrate. Further as described in this method, the uncooked meat is poultry or pork. As discussed above, certain exemplary embodiments are also shown in FIG. 2.

The present invention teaches that whey protein concentrates inconsistently affect the pink color defect in cooked ground turkey and that major whey protein concentrate constituents (β-lactoglobulin, α-lactalbumin, lactose) tested alone do not influence cooked ground turkey color. Calcium chloride, which is a constituent of whey protein concentrates, consistently minimizes the pink color defect in cooked ground turkey due to sodium nitrite and nicotinamide. Calcium chloride generally appears to require the presence of phosphate to minimize the pink color defect in cooked ground turkey. Moreover, calcium in the form of calcium chloride also appears minimize the pink color defect in intact turkey breast.

Following examples illustrate and demonstrate the invention in terms of preferred embodiments. These examples are for illustrative purpose only and should not be deemed to narrow the scope the present invention as claimed. These inventions have been described in terms of light colored meat which is intact or ground turkey, however, one of ordinary skill in the art would appreciate that this invention would be easily applied to other light colored meat, such as other poultry, e.g. chicken, or pork, without undue experimentations based on the teachings of this inventions and other methodologies well known and established in the art.

### EXAMPLE I

Identifying Constituents of Whey Protein Concentrates that Reduce the Pink Color Defect in Cooked Ground Turkey

Whey protein concentrate constituents were tested for their ability to reduce naturally occurring pink color defect and pink cooked color induced by sodium nitrite (10 ppm) and nicotinamide (1.0%) in ground turkey. β-lactoglobulin (1.8%), α-lactalbumin (0.8%), bovine serum albumin (0.15-0.3%), lactose (1.0-3.0%), potassium chloride (500-1500 ppm), and ferrous iron chloride (0.3-30 ppm) had no effects on cooked pink color. Lactoferrin (30-5000 ppm) increased or decreased pink color depending on its concentration in samples without added sodium nitrite or nicotinamide. Annatto (0.1-1.0 ppm) reduced pink color whereas the higher concentration of magnesium chloride (22-88 ppm) and ferric iron chloride (0.3-30 ppm) increased pink color in samples with added nicotinamide. Calcium chloride (160-480 ppm) was the only tested constituent that consistently reduced pink cooked color in samples with and without added nitrite and nicotinamide. Due to the variability of whey protein concentrates and the number of constituents that do not reduce pink cooked color, the addition of calcium alone or dried milk minerals containing calcium, phosphate, and citrate, represents a better means to regularly prevent the pink color defect in cooked ground turkey.

Materials and Methods

Turkey Preparation

Fresh, boneless, skinless turkey breasts (pectoralis major) received from a local processor 2 d postmortem were coarsely ground (9 mm plate; Grinder model 5323, Toledo Chopper, Toledo, Ohio), mixed (Model A120T, Hobart Corporation, Troy, Ohio) for 4 min, vacuum packaged (barrier bag #212-02006, Sealtite, West Bridgewater, Mass.; Supervac GK184/B, Smith Equipment Company, Clifton, N.J.), and stored at −27° C. for 2-4 months. The turkey was thawed for 24-48 h at 2° C., and finely ground twice through a 4.67 mm plate for ground turkey sample preparation. Three batches were created which received 1 of 3 pinking treatments (none, 10 ppm sodium nitrite; NT, 1% nicotinamide; NC) in 10% distilled, deionized water based on the meat weight and were mixed for 1 min (Model #62509; Hamilton Beach/Proctor-Silex Inc, Washington, N.C.). Both NT (#S2251) and NC (#N3376) were purchased from Sigma-Aldrich Co. (St. Louis, Mo.). Smaller portions (100 g) were separated from the 3 batches, which received 2% sodium chloride and 0.5% sodium tripolyphosphate in 20% distilled, deionized water based on the meat weight. One of 11 whey protein concentrate (WPC) constituents also was added. Each batch was mixed for 1 min and stuffed into 2 conical centrifuge tubes, approximately 50 g each.

The 11 WPC constituents were β-lactoglobulin (0, 1.8%), α-lactalbumin (0, 0.6%), bovine serum albumin (BSA; 0, 0.15, 0.3%), lactoferrin (0, 30, 300, 5000 ppm; DMV International, Delhi, N.Y.), lactose (0, 1.0, 2.0, 3.0%), double strength annatto (0, 0.1, 1.0, 10 ppm; Gist-Brocades International, Menomonee Falls, Wis.), potassium chloride (0, 500, 1000, 1500 ppm), magnesium chloride (0, 22, 44, 88 ppm), ferrous iron chloride tetrahydrate (0, 0.3, 3.0, 30 ppm), ferric iron chloride hexahydrate (0, 0.3, 3.0, 30 ppm), and calcium chloride (0, 160, 320, 480 ppm). All ingredients except for β-lactoglobulin, α-lactalbumin, lactoferrin, and annatto were purchased from Sigma-Aldrich Co. The minerals, lactoferrin, and annatto were dissolved in solution with sodium chloride and sodium tripolyphosphate before addition to the ground turkey whereas the other ingredients were added dry. The percentage of WPC constituent added were based on approximate percentages that would have been added to ground turkey with the addition of 3% WPC (356 and 392; Foremost Farms USA, Baraboo, Wis. For example, β-lactoglobulin represents approximately 60% of WPC. Therefore if WPC were added at 3%, 1.8% β-lactoglobulin would be present. Two concentrations of BSA were tested since there is more variability of minor proteins in WPCs and 3 concentrations of lactoferrin were tested for variability as well as its known iron binding properties. All minerals were tested at 3 levels, with the lowest level representing the approximate amount added if 3% WPC were added to ground turkey. The concentration of annatto present in WPC is unknown, therefore small levels, similar to the levels of iron, were tested.

β-lactoglobulin and α-lactalbumin were separated from WPC (392; Foremost Farms USA, Baraboo, Wis.) by ion exchange chromatography on DEAE Sepharose (#17-0709-10, Amersham Biosciences, Piscataway, N.J.). The column was equilibrated with 45 mM imidazole-HCl buffer (pH 7.5) and adsorbed proteins were eluted with a linear gradient of 0 to 250 mM NaCl (Imafidon and others 1997). Protein purity was confirmed by SDS-PAGE. Fractions containing β-lactoglobulin and α-lactalbumin were pooled respectively, dialyzed against distilled, deionized water for 24 h (3 changes), and lyophilized before addition to ground turkey.

Stuffed tubes were centrifuged for 20 min at 2000×g to remove air pockets and stored overnight at 2° C. The samples were cooked the following day to 80° C. in a 90° C. water bath (Isotemp 228, Fisher Scientific, Pittsburg, Pa.). Temperature was monitored with placement of a thermocouple in the center of every six samples. Thermocouples were attached to a 12-channel thermocouple scanner (Model #92000-00, Cole Parmer Instrument Company, Barrington, Ill.). Cooked samples were cooled for 20 min in ice and stored overnight at 2° C.

Analysis

A chroma meter (CR-300, 1-cm aperture, illuminant C; Minolta Corp., Osaka, Japan) and ultraviolet/visible scanning spectrophotometer (Model 2101PC; Shimadzu Inc.) were used to measure CIE L*a*b* values and reflectance from 400-700 nm with 1-nm increments, respectively. Both instruments were calibrated with a white plate (L* 97.06, a* −0.14, b* 1.93) and measurements were taken in duplicate (one measurement per tube) on freshly cut surfaces. Nitrosylhemochrome was estimated on samples without a pinking treatment and samples containing added NT using the percent reflectance ratio 650 nm/570 nm (AMSA, 1991). Nicotinamide hemochrome was estimated on samples without a pinking treatment and samples containing added NC using the percent reflectance ratio 537 nm/553 nm (Schwarz and others 1998). Percent yield was calculated as: [(cooked sample weight/raw sample weight)×100]. The pH was measured on a 5-g cooked turkey sample homogenized in 50 ml distilled, deionized water with a pH electrode (910600; Thermo Orion, Beverly, Mass.) attached to a pH meter (Accumet AR50; Fisher Scientific, Pittsburgh, Pa.). Data were analyzed as a completely randomized split-split-plot where the 3 pinking treatments represented the first split and subsequent smaller batches for WPC constituent addition represented the second split. Proc Mixed of SAS (2000) was used to determine treatment differences and means were separated (p<0.05) by pairwise comparisons using the pdiff option. The experiment was replicated 3 times.

Results and Discussion

Proteins

The addition of β-lactoglobulin, α-lactalbumin, and BSA to ground turkey samples had few effects on CIE L*, a*, b* values, pigment concentrations, pH, and cooking yields (Table 1-4). β-lactoglobulin decreased (p<0.05) lightness (L* value) and yellowness (b* value) in samples containing added NC while having no effects on redness (a* value) regardless of pinking treatment (Table 1). β-lactoglobulin did not influence (p>0.05) nitrosylhemochrome and nicotinamide hemochrome concentrations, pH, or cooking yields. α-lactalbumin had no effects (p>0.05) on color traits and slightly increased (p<0.05) pH compared to the control, over all pinking treatments (Table 2). Cooking yields of NT containing samples were increased (p<0.05) by the addition of α-lactalbumin. Bovine serum albumin did not (p>0.05) influence traits measured in this study (Table 3). This is in agreement with Ahn and Maurer (1990a) who also found BSA to have no impact on color characteristics of turkey breast.

TABLE 1
β-lactoglobulin effects on mean CIE L*, a*, b* values,
nitrosylhemochrome, nicotinamide hemochrome, pH,
and percent cooking yields of cooked ground turkey
formulated with different pink-color-inducing ligands
(no ligand, 10 ppm sodium nitrite; NT,
1% nicotinamide; NC).

| | | | | | Standard |
|---|---|---|---|---|---|
| Trait | β-lactoglobulin | No Ligand | NT | NC | Error |
| L* values | 0% | 78.6 | 78.3 | 76.9^{a} | 0.20 |
| | 1.8% | 78.9 | 78.5 | 76.1^{b} | |
| a* values | 0% | 4.9 | 6.0 | 6.6 | 0.25 |
| | 1.8% | 4.7 | 5.9 | 6.9 | |
| b* values | 0% | 7.3 | 5.8 | 5.4^{a} | 0.37 |
| | 1.8% | 7.9 | 5.6 | 4.7^{b} | |
| Nitrosyl- | 0% | 1.25 | 1.44 | — | 0.015 |
| Hemochrome^{c} | 1.8% | 1.24 | 1.43 | — | |
| Nicotinamide | 0% | 1.06 | — | 1.17 | 0.012 |
| hemochrome^{d} | 1.8% | 1.06 | — | 1.19 | |
| pH | 0% | 6.32 | 6.32 | 6.37 | 0.006 |
| | 1.8% | 6.33 | 6.33 | 6.38 | |
| Yield, % | 0% | 96.8 | 95.6 | 98.1 | 0.87 |
| | 1.8% | 96.8 | 96.7 | 98.4 | |

^{a-b}Means in the same column and trait with different superscript letters differ (p < 0.05).
^{c}Nitrosylhemochrome; percent reflectance 650 nm/percent reflectance 570 nm (greater values indicate higher concentrations of nitrosylhemochrome).
^{d}Nicotinamide hemochrome; percent reflectance 537 nm/percent reflectance 553 nm (greater values indicate higher concentrations of nicotinamide hemochrome).

TABLE 2
α-lactalbumin effects on mean CIE L*, a*, b* values,
nitrosylhemochrome, nicotinamide hemochrome, pH,
and percent cooking yields of cooked ground turkey
formulated with different pink-color-inducing ligands
(no ligand, 10 ppm sodium nitrite;
NT, 1% nicotinamide; NC).

| | | No | | | Standard |
|---|---|---|---|---|---|
| Trait | α-lactalbumin | Ligand | NT | NC | Error |
| L* values | 0% | 78.6 | 78.3 | 76.9 | 0.20 |
| | 0.6% | 78.7 | 78.2 | 76.5 | |
| a* values | 0% | 4.9 | 6.0 | 6.6 | 0.25 |
| | 0.6% | 4.6 | 5.9 | 6.6 | |
| b* values | 0% | 7.3 | 5.8 | 5.4 | 0.37 |
| | 0.6% | 7.6 | 5.6 | 4.9 | |
| Nitrosyl- | 0% | 1.25 | 1.44 | — | 0.015 |
| Hemochrome^{c} | 0.6% | 1.25 | 1.43 | — | |
| Nicotinamide | 0% | 1.06 | — | 1.17 | 0.012 |
| hemochrome^{d} | 0.6% | 1.05 | — | 1.18 | |
| pH | 0% | 6.32^{b} | 6.32^{b} | 6.37^{b} | 0.006 |
| | 0.6% | 6.36^{a} | 6.35^{a} | 6.40^{a} | |
| Yield, % | 0% | 96.8 | 95.6^{b} | 98.1 | 0.87 |
| | 0.6% | 98.3 | 97.7^{a} | 98.3 | |

^{a-b}Means in the same column and trait with different superscript letters differ (p < 0.05).
^{c}Nitrosylhemochrome; percent reflectance 650 nm/percent reflectance 570 nm (greater values indicate higher concentrations of nitrosylhemochrome).
^{d}Nicotinamide hemochrome; percent reflectance 537 nm/percent reflectance 553 nm (greater values indicate higher concentrations of nicotinamide hemochrome).

TABLE 3
Bovine serum albumin (BSA) effects on mean CIE L*, a*, b* values,
nitrosylhemochrome, nicotinamide hemochrome, pH, and
percent cooking yields of cooked ground turkey formulated with
different pink-color-inducing ligands (no ligand, 10 ppm
sodium nitrite; NT, 1% nicotinamide; NC).

| | | | | | Standard |
|---|---|---|---|---|---|
| Trait | BSA | No Ligand | NT | NC | Error |
| L* values | 0% | 78.9 | 77.9 | 77.7 | 0.43 |
| | 0.15% | 79.3 | 78.4 | 77.7 | |
| | 0.3% | 79.5 | 78.6 | 77.7 | |
| a* values | 0% | 4.4 | 6.0 | 6.6 | 0.22 |
| | 0.15% | 4.4 | 6.0 | 6.6 | |
| | 0.3% | 4.4 | 6.1 | 6.6 | |
| b* values | 0% | 7.8 | 5.5 | 5.7 | 0.25 |
| | 0.15% | 7.9 | 5.6 | 5.9 | |
| | 0.3% | 8.0 | 5.7 | 5.8 | |
| Nitrosyl- | 0% | 1.23 | 1.44 | — | 0.010 |
| Hemochrome^{c} | 0.15% | 1.23 | 1.45 | — | |
| | 0.3% | 1.22 | 1.44 | — | |
| Nicotinamide | 0% | 1.05 | — | 1.16 | 0.006 |
| hemochrome^{d} | 0.15% | 1.05 | — | 1.16 | |
| | 0.3% | 1.05 | — | 1.16 | |
| pH | 0% | 6.39 | 6.37 | 6.41 | 0.014 |
| | 0.15% | 6.37 | 6.39 | 6.41 | |
| | 0.3% | 6.38 | 6.38 | 6.43 | |
| Yield, % | 0% | 93.8 | 94.0 | 95.1^{ab} | 0.87 |
| | 0.15% | 94.7 | 94.3 | 93.8^{b} | |
| | 0.3% | 94.0 | 93.9 | 95.8^{a} | |

^{a-b}Means in the same column and trait with different superscript letters differ (p < 0.05).
^{c}Nitrosylhemochrome; percent reflectance 650 nm/percent reflectance 570 nm (greater values indicate higher concentrations of nitrosylhemochrome).
^{d}Nicotinamide hemochrome; percent reflectance 537 nm/percent reflectance 553 nm (greater values indicate higher concentrations of nicotinamide hemochrome).

TABLE 4
Lactoferrin effects on mean CIE L*, a*, b* values, nitrosylhemochrome,
nicotinamide hemochrome, pH, and percent cooking yields of
cooked ground turkey formulated with different pink-color-inducing
ligands (no ligand, 10 ppm sodium nitrite; NT, 1% nicotinamide, NC).

| | | | | | | Standard |
|---|---|---|---|---|---|---|
| Trait | Lactoferrin | | No Ligand | NT | NC | Error |
| L* values | 0 | ppm | 78.9^{bc} | 77.9^{b} | 77.7 | 0.43 |
| | 30 | ppm | 79.9^{a} | 79.4^{a} | 77.2 | |
| | 300 | ppm | 79.6^{ab} | 77.9^{b} | 77.4 | |
| | 5000 | ppm | 78.7^{c} | 78.1^{b} | 77.2 | |
| a* values | 0 | ppm | 4.4^{b} | 6.0 | 6.6 | 0.25 |
| | 30 | ppm | 5.0^{a} | 6.3 | 6.5 | |
| | 300 | ppm | 4.2^{bc} | 6.1 | 6.6 | |
| | 5000 | ppm | 4.0^{c} | 6.0 | 6.4 | |
| b* values | 0 | ppm | 7.8 | 5.5 | 5.7 | 0.25 |
| | 30 | ppm | 8.2 | 5.9 | 6.1 | |
| | 300 | ppm | 8.2 | 5.6 | 5.7 | |
| | 5000 | ppm | 8.0 | 5.5 | 5.8 | |
| Nitrosylhemochrome^{d} | 0 | ppm | 1.23^{ab} | 1.44^{ab} | — | 0.010 |
| | 30 | ppm | 1.23^{a} | 1.46^{a} | — | |
| | 300 | ppm | 1.22^{ab} | 1.43^{b} | — | |
| | 5000 | ppm | 1.21^{b} | 1.43^{b} | — | |
| Nicotinamide | 0 | ppm | 1.05^{ab} | — | 1.16^{a} | 0.006 |
| hemochrome^{e} | 30 | ppm | 1.06^{a} | — | 1.14^{b} | |
| | 300 | ppm | 1.04^{b} | — | 1.15^{ab} | |
| | 5000 | ppm | 1.05^{b} | — | 1.16^{a} | |
| pH | 0 | ppm | 6.39 | 6.37 | 6.41 | 0.014 |
| | 30 | ppm | 6.37 | 6.37 | 6.43 | |
| | 300 | ppm | 6.38 | 6.38 | 6.43 | |
| | 5000 | ppm | 6.37 | 6.38 | 6.42 | |
| Yield, % | 0 | ppm | 93.8^{a} | 94.0^{a} | 95.1 | 0.87 |
| | 30 | ppm | 91.7^{b} | 91.2^{b} | 94.6 | |
| | 300 | ppm | 94.1^{a} | 94.6^{a} | 94.8 | |
| | 5000 | ppm | 95.1^{a} | 94.4^{a} | 95.5 | |

^{a-c}Means in the same column and trait with different superscript letters differ (p < 0.05).
^{d}Nitrosylhemochrome; percent reflectance 650 nm/percent reflectance 570 nm (greater values indicate higher concentrations of nitrosylhemochrome).
^{e}Nicotinamide hemochrome; percent reflectance 537 nm/percent reflectance 553 nm (greater values indicate higher concentrations of nicotinamide hemochrome).

The major whey proteins, especially β-lactoglobulin, are known to interact with muscle proteins forming complex gel matrices. In the native form, whey proteins have sulfhydryl groups that are buried within the folded tertiary structure (De Wit 1998). However, upon heat denaturation, the proteins unfold and expose sulfhydryl groups and hydrophobic surfaces, which are involved in subsequent aggregation with muscle proteins. Dobson and Cornforth (1992) speculated that these reactive sulfhydryl groups or other amino acid side chains exposed during heating might raise the oxidation-reduction potential of the meat system. Higher oxidation-reduction potentials prevent the complexing of denatured proteins with heme pigments. However, sulfhydryl groups have been shown to act as free radicals and antioxidants preventing lipid oxidation (Tong and others 2000), which would reduce the oxidation-reduction potential of the meat system Dobson and Cornforth also suggested that NFDM might decrease muscle protein denaturation during cooking, resulting in less hemochrome formation. Although this study did not measure protein denaturation, β-lactoglobulin, α-lactalbumin, or BSA did not influence the level of nicotinamide hemochrome. In an attempt to explain reduced pink color due to NFDM, Schwarz and others (1997) offered competitive binding of NFDM rather than pink-color-generating ligands to the heme ring of pigments. Ahn and Maurer (1990b) demonstrated pink color generation in solution upon complex formation of sulfhydryl groups of cysteine with myoglobin, hemoglobin, or cytochrome c. Although complex formation of whey proteins and heme pigments may have occurred upon heating of the ground turkey samples, complexes did not increase or decrease pink color and were not sufficient to prevent NT or NC from binding heme iron.

Conversely to the other whey proteins tested, lactoferrin had some effects on color traits of the cooked ground turkey samples (Table 4). Lactoferrin at 30 ppm increased (p<0.05) lightness compared to the control when NT or no pink-color-generating ligand was added. Redness was increased by 30 ppm lactoferrin and decreased by 5000 ppm lactoferrin compared to the control in samples without added NT or NC (p<0.05). Lactoferrin did not affect (p>0.05) yellowness. Lactoferrin (30 ppm) reduced (p<0.05) nicotinamide hemochrome when NC was added to samples. Cooking yields and pH were not affected (p>0.05) by lactoferrin except cooking yields were reduced (p<0.05) by 30 ppm lactoferrin when NT or no pink-color-generating ligand was added to the samples.

Lactoferrin is an iron-binding protein that has received much attention due to its bacteriostatic and bactericidal activity. Lactoferrin not only sequesters environmental iron needed by bacteria, but also binds the outer membrane of gram-negative bacteria causing direct destruction of bacterial cells (Shimazaki 2000). In the absence of iron, lactoferrin is colorless and exhibits red-brown color when iron is bound (Morr and Ha 1993). Commercial bovine lactoferrin is saturated with approximately 22% iron. Upon heating to 80 or 90° C. in solution, the pink color of lactoferrin disappeared but reappeared upon cooling (Kawakami and others 1992). It was thought that high temperatures caused release of iron from lactoferrin, which then renatured upon cooling. However, in combination with meat proteins, renaturation of lactoferrin may not occur. It is also possible that lactoferrin may become more saturated with iron in meat systems, intensifying pink color.

It is interesting that samples containing 30 ppm lactoferrin had greater (p<0.05) amounts of nitrosylhemochrome than samples containing 5000 ppm lactoferrin (Table 4). Additionally, samples containing 30 ppm lactoferrin had higher (p<0.05) levels of nicotinamide hemochrome than samples with 5000 ppm lactoferrin when no pink-color-generating ligand was added. However, upon the addition of NC, the reverse situation was true in which more (p<0.05) nicotinamide hemochrome was present in samples with 5000 ppm than 30 ppm lactoferrin. The reason for these differences is not known, but may be related to iron sequestering or interactions of lactoferrin with the heme ring of pigments or pink-color-generating ligands. The addition of a specific concentration of lactoferrin to ground turkey may be ideal for preventing the pink color defect. This may represent a reasonable means for reducing the pink color defect, as lactoferrin is already bulk manufactured and used as an antimicrobial in processed meat products.

Lactose and Annatto

Lactose did not affect cooked turkey color except 3.0% lactose decreased lightness in samples with added NT compared to the control and 2.0% lactose decreased yellowness in samples without added NT or NC (p<0.05; Table 5). Annatto is a red vegetable dye obtained from the seed coat of the fruit of the Annatto tree and is used in cheese manufacturing to give some cheese, such as Cheddar, an orange color. Since whey is a by-product of cheese manufacturing, some annatto may be present in WPCs depending upon the cheese from which it comes from. Thus small concentrations of annatto were tested in ground turkey to see whether it has an effect on color (Table 6). Visually, 0.1 or 1.0 ppm annatto did not unusually influence color, however 10 ppm annatto gave the turkey samples an unnatural orange color. Although data for 10 ppm annatto is reported, it will not be discussed, as WPCs does not turn turkey orange and thus must not contain amounts near 10 ppm of annatto. Addition of 0.1 and 1.0 ppm annatto to the samples did not affect (p>0.05) lightness, and both reduced (p<0.05) redness compared to the control in samples containing added NC. Yellowness was increased by 1.0 ppm annatto compared to the control regardless of pinking treatment and increased by 0.1 ppm annatto only in samples with added NC. Nitrosylhemochrome was increased (p<0.05) by 0.1 ppm annatto in samples with added NT and both 0.1 and 1.0 ppm annatto reduced (p<0.05) nicotinamide hemochrome compared to the control in samples with added NC. It was surprising that annatto decreased redness in samples with added NC and decreased nicotinamide hemochrome. The reason for this is unknown and perhaps, may be related to interference of nicotinamide's access to heme iron by annatto.

TABLE 5
Lactose effects on mean CIE L*, a*, b* values, nitrosylhemochrome,
nicotinamide hemochrome, pH, and percent cooking yields of cooked
ground turkey formulated with different pink-color-inducing ligands
(no ligand, 10 ppm sodium nitrite; NT, 1% nicotinamide; NC).

| | | | | | Standard |
|---|---|---|---|---|---|
| Trait | Lactose | No Ligand | NT | NC | Error |
| L* values | 0% | 75.9 | 75.1^{a} | 74.3 | 0.28 |
| | 1.0% | 75.6 | 74.8^{ab} | 74.2 | |
| | 2.0% | 75.8 | 74.8^{ab} | 74.0 | |
| | 3.0% | 75.3 | 74.3^{b} | 73.8 | |
| a* values | 0% | 4.4 | 6.3 | 8.8 | 0.40 |
| | 1.0% | 4.5 | 6.0 | 8.6 | |
| | 2.0% | 4.5 | 5.9 | 8.7 | |
| | 3.0% | 4.6 | 6.0 | 8.9 | |
| b* values | 0% | 7.4^{a} | 5.2 | 4.2^{ab} | 0.21 |
| | 1.0% | 7.0^{ab} | 4.9 | 4.3^{a} | |
| | 2.0% | 6.9^{b} | 4.9 | 4.2^{ab} | |
| | 3.0% | 7.0^{ab} | 4.9 | 3.8^{b} | |
| Nitrosyl- | 0% | 1.23 | 1.44 | — | 0.016 |
| Hemochrome^{c} | 1.0% | 1.23 | 1.44 | — | |
| | 2.0% | 1.23 | 1.44 | — | |
| | 3.0% | 1.23 | 1.46 | — | |
| Nicotinamide | 0% | 1.05 | — | 1.22 | 0.014 |
| hemochrome^{d} | 1.0% | 1.05 | — | 1.22 | |
| | 2.0% | 1.06 | — | 1.22 | |
| | 3.0% | 1.06 | — | 1.23 | |
| pH | 0% | 6.28 | 6.30 | 6.33 | 0.016 |
| | 1.0% | 6.30 | 6.31 | 6.33 | |
| | 2.0% | 6.30 | 6.31 | 6.33 | |
| | 3.0% | 6.30 | 6.30 | 6.34 | |
| Yield, % | 0% | 92.9 | 94.4 | 94.4 | 1.34 |
| | 1.0% | 94.6 | 92.9 | 95.2 | |
| | 2.0% | 85.4 | 92.9 | 94.7 | |
| | 3.0% | 94.6 | 94.6 | 94.9 | |

^{a-b}Means in the same column and trait with different superscript letters differ (p < 0.05).
^{c}Nitrosylhemochrome; percent reflectance 650 nm/percent reflectance 570 nm (greater values indicate higher concentrations of nitrosylhemochrome).
^{d}Nicotinamide hemochrome; percent reflectance 537 nm/percent reflectance 553 nm (greater values indicate higher concentrations of nicotinamide hemochrome).

TABLE 6
Annatto effects on mean CIE L*, a*, b* values, nitrosylhemochrome,
nicotinamide hemochrome, pH, and percent cooking yields of cooked
ground turkey formulated with different pink-color-inducing ligands
(no ligand, 10 ppm sodium nitrite; NT, 1% nicotinamide; NC).

| | | | | | Standard |
|---|---|---|---|---|---|
| Trait | Annatto | No Ligand | NT | NC | Error |
| L* values | 0 ppm | 78.3^{a} | 77.2^{a} | 75.8^{a} | 0.22 |
| | 0.1 ppm | 78.4^{a} | 77.5^{a} | 75.9^{a} | |
| | 1.0 ppm | 78.2^{a} | 77.1^{a} | 75.9^{a} | |
| | 10 ppm | 77.2^{b} | 75.8^{b} | 75.3^{b} | |
| a* values | 0 ppm | 4.6 | 6.2 | 7.5^{a} | 0.20 |
| | 0.1 ppm | 4.7 | 6.3 | 6.7^{bc} | |
| | 1.0 ppm | 4.7 | 6.3 | 7.0^{b} | |
| | 10 ppm | 5.0 | 6.4 | 6.5^{c} | |
| b* values | 0 ppm | 7.4^{c} | 5.4^{c} | 4.5^{c} | 0.33 |
| | 0.1 ppm | 7.9^{c} | 5.8^{c} | 5.3^{b} | |
| | 1.0 ppm | 8.7^{b} | 6.8^{b} | 6.0^{b} | |
| | 10 ppm | 15.3^{a} | 14.1^{a} | 11.2^{a} | |
| Nitrosyl- | 0 ppm | 1.22 | 1.45^{b} | — | 0.010 |
| Hemochrome^{e} | 0.1 ppm | 1.22 | 1.48^{a} | — | |
| | 1.0 ppm | 1.22 | 1.46^{ab} | — | |
| | 10 ppm | 1.23 | 1.48^{a} | — | |
| Nicotinamide | 0 ppm | 1.06^{a} | — | 1.20^{a} | 0.005 |
| hemochrome^{f} | 0.1 ppm | 1.06^{a} | — | 1.18^{c} | |
| | 1.0 ppm | 1.06^{a} | — | 1.19^{b} | |
| | 10 ppm | 1.04^{b} | — | 1.16^{d} | |
| pH | 0 ppm | 6.31^{a} | 6.28 | 6.31 | 0.012 |
| | 0.1 ppm | 6.29^{b} | 6.27 | 6.31 | |
| | 1.0 ppm | 6.28^{b} | 6.29 | 6.31 | |
| | 10 ppm | 6.30^{ab} | 6.28 | 6.30 | |
| Yield, % | 0 ppm | 94.8^{b} | 95.9 | 97.9^{a} | 0.47 |
| | 0.1 ppm | 95.0^{b} | 95.9 | 96.7^{b} | |
| | 1.0 ppm | 96.0^{a} | 95.4 | 97.5^{ab} | |
| | 10 ppm | 95.0^{b} | 96.1 | 97.5^{ab} | |

^{a-d}Means in the same column and trait with different superscript letters differ (p < 0.05).
^{e}Nitrosylhemochrome; percent reflectance 650 nm/percent reflectance 570 nm (greater values indicate higher concentrations of nitrosylhemochrome).
^{f}Nicotinamide hemochrome; percent reflectance 537 nm/percent reflectance 553 nm (greater values indicate higher concentrations of nicotinamide hemochrome).

Minerals

The effects of minerals on cooked ground turkey are given in Tables 7-11. When only considering the lowest concentrations of each mineral (the concentration that approximates the amount added to turkey with 3% WPC), only calcium chloride decreased (p<0.05) redness compared to the control in samples containing NC (Table 11). However, such concentrations are only an approximation and it is quite feasible that higher or even lower concentrations of each mineral are present in WPCs due to whey source and processing treatment. At only parts per million, the concentrations of minerals in WPCs could sometimes be double or triple the estimated amounts and such concentrations had more effects on cooked color of ground turkey.

Potassium chloride decreased (p<0.05) lightness compared to the control when added at 1500 ppm to samples with additional NT (Table 7). Yellowness was increased by 1500 ppm potassium chloride in samples without a pink-color-generating ligand and decreased by all concentrations of potassium chloride in samples with added NC (p<0.05). Potassium chloride at 500 and 1500 ppm increased (p<0.05) nicotinamide hemochrome compared to the control in samples with added NC. In samples containing added NC, 88 ppm magnesium chloride increased (p<0.05) redness and all concentrations of magnesium chloride reduced (p<0.05) yellowness (Table 8).

TABLE 7
Potassium chloride effects on mean CIE L*, a*, b* values,
nitrosylhemochrome, nicotinamide hemochrome, pH, and
percent cooking yields of cooked ground turkey formulated
with different pink-color-inducing ligands (no ligand,
10 ppm sodium nitrite; NT, 1% nicotinamide, NC).

| | Potassium | No | | | Standard |
|---|---|---|---|---|---|
| Trait | Chloride | Ligand | NT | NC | Error |
| L* values | 0 ppm | 76.1 | 76.1^{a} | 74.0 | 0.24 |
| | 500 ppm | 76.2 | 76.1^{a} | 74.1 | |
| | 1000 ppm | 76.0 | 76.0^{a} | 73.9 | |
| | 1500 ppm | 76.2 | 75.4^{b} | 74.1 | |
| a* values | 0 ppm | 4.4 | 6.0 | 7.7^{ab} | 0.22 |
| | 500 ppm | 4.2 | 6.1 | 7.9^{ab} | |
| | 1000 ppm | 4.2 | 6.2 | 7.4^{b} | |
| | 1500 ppm | 4.0 | 6.2 | 8.1^{a} | |
| b* values | 0 ppm | 6.8^{b} | 5.3 | 4.5^{a} | 0.13 |
| | 500 ppm | 6.9^{ab} | 5.4 | 3.9^{c} | |
| | 1000 ppm | 6.8^{b} | 5.4 | 4.2^{b} | |
| | 1500 ppm | 7.1^{a} | 5.1 | 4.0^{bc} | |
| Nitrosylhemochrome^{d} | 0 ppm | 1.22 | 1.44 | — | 0.022 |
| | 500 ppm | 1.22 | 1.42 | — | |
| | 1000 ppm | 1.22 | 1.45 | — | |
| | 1500 ppm | 1.21 | 1.44 | — | |
| Nicotinamide | 0 ppm | 1.05 | — | 1.19^{b} | 0.004 |
| hemochrome^{e} | 500 ppm | 1.05 | — | 1.20^{a} | |
| | 1000 ppm | 1.04 | — | 1.19^{ab} | |
| | 1500 ppm | 1.04 | — | 1.20^{a} | |
| pH | 0 ppm | 6.51 | 6.41 | 6.51 | 0.009 |
| | 500 ppm | 6.50 | 6.41 | 6.50 | |
| | 1000 ppm | 6.51 | 6.41 | 6.50 | |
| | 1500 ppm | 6.50 | 6.41 | 6.49 | |
| Yield, % | 0 ppm | 91.4 | 88.9 | 94.7 | 1.7 |
| | 500 ppm | 90.4 | 86.0 | 95.0 | |
| | 1000 ppm | 91.3 | 86.9 | 96.1 | |
| | 1500 ppm | 92.1 | 89.4 | 94.4 | |

^{a-c}Means in the same column and trait with different superscript letters differ (p < 0.05).
^{d}Nitrosylhemochrome; percent reflectance 650 nm/percent reflectance 570 nm (greater values indicate higher concentrations of nitrosylhemochrome).
^{e}Nicotinamide hemochrome; percent reflectance 537 nm/percent reflectance 553 nm (greater values indicate higher concentrations of nicotinamide hemochrome).

TABLE 8
Magnesium chloride effects on mean CIE L*, a*, b* values,
nitrosylhemochrome, nicotinamide hemochrome, pH, and
percent cooking yields of cooked ground turkey formulated
with different pink-color-inducing ligands (no ligand,
10 ppm sodium nitrite; NT, 1% nicotinamide, NC).

| | Magnesium | | | | Standard |
|---|---|---|---|---|---|
| Trait | Chloride | No Ligand | NT | NC | Error |
| L* values | 0 ppm | 75.2 | 74.0 | 73.2 | 0.30 |
| | 22 ppm | 75.0 | 74.0 | 73.1 | |
| | 44 ppm | 74.8 | 74.5 | 73.3 | |
| | 88 ppm | 75.0 | 74.2 | 73.3 | |
| a* values | 0 ppm | 5.0 | 6.1 | 8.1^{b} | 0.28 |
| | 22 ppm | 4.6 | 6.1 | 8.7^{ab} | |
| | 44 ppm | 4.8 | 6.1 | 8.6^{ab} | |
| | 88 ppm | 4.8 | 6.0 | 9.0^{a} | |
| b* values | 0 ppm | 6.1 | 4.5 | 3.4^{a} | 0.11 |
| | 22 ppm | 6.1 | 4.4 | 3.1^{b} | |
| | 44 ppm | 5.8 | 4.4 | 3.1^{b} | |
| | 88 ppm | 5.7 | 4.6 | 2.9^{b} | |
| Nitrosyl- | 0 ppm | 1.23 | 1.43^{b} | — | 0.020 |
| Hemochrome^{c} | 22 ppm | 1.22 | 1.46^{ab} | — | |
| | 44 ppm | 1.23 | 1.46^{ab} | — | |
| | 88 ppm | 1.23 | 1.48^{b} | — | |
| Nicotinamide | 0 ppm | 1.06 | — | 1.18 | 0.024 |
| hemochrome^{d} | 22 ppm | 1.06 | — | 1.23 | |
| | 44 ppm | 1.06 | — | 1.22 | |
| | 88 ppm | 1.09 | — | 1.22 | |
| pH | 0 ppm | 6.35 | 6.36 | 6.36 | 0.014 |
| | 22 ppm | 6.37 | 6.35 | 6.36 | |
| | 44 ppm | 6.35 | 6.33 | 6.35 | |
| | 88 ppm | 6.35 | 6.34 | 6.34 | |
| Yield, % | 0 ppm | 94.2 | 93.1 | 96.3 | 1.4 |
| | 22 ppm | 94.5 | 93.5 | 95.1 | |
| | 44 ppm | 94.2 | 93.8 | 93.3 | |
| | 88 ppm | 94.1 | 94.0 | 93.7 | |

^{a-b}Means in the same column with different superscript letters differ (p < 0.05).
^{c}Nitrosylhemochrome; percent reflectance 650 nm/percent reflectance 570 nm (greater values indicate higher concentrations of nitrosylhemochrome).
^{d}Nicotinamide hemochrome; percent reflectance 537 nm/percent reflectance 553 nm (greater values indicate higher concentrations of nicotinamide hemochrome).

Both ferrous and ferric iron chloride were tested for their effects on cooked turkey color because they play a significant role in both pigment and lipid oxidation. Ferrous iron participates in the Fenton reaction where it reacts with hydrogen peroxide to produce hydroxyl radical (Wardman and Candeias 1996), which subsequently can enhance oxidation of lipids and heme pigments. Ferric iron accelerates autoxidation by creating more electronically favorable conditions to reduce oxygen by 2 electrons (Livingston and Brown 1981) and may also be reduced by superoxide anion to ferrous iron. Due to iron's oxidative ability, it was surprising that neither ferrous nor ferric iron chloride reduced pink color in cooked turkey samples (Tables 9 and 10). Ferrous iron chloride at 30 ppm increased yellowness and decreased cooking yields compared to the control in samples containing added NC (p<0.05; Table 9). All concentrations of ferric iron chloride increased (p<0.05) lightness in samples with added NT and no pink-color-generating ligand (Table 10). In samples without added NT or NC, both 3.0 and 30 ppm ferric iron chloride increased redness and yellowness and decreased pH and cooking yields when compared to the control (p<0.05). In samples with added NT, 30 ppm ferric iron chloride increased yellowness and decreased cooking yields compared to the control (p<0.05).

TABLE 9
Ferrous iron chloride effects on mean CIE L*, a*, b* values,
nitrosylhemochrome, nicotinamide hemochrome, pH, and
percent cooking yields of cooked ground turkey formulated with
different pink-color-inducing ligands (no ligand, 10 ppm
sodium nitrite; NT, 1% nicotinamide, NC).

| | Ferrous iron | | | | Standard |
|---|---|---|---|---|---|
| Trait | Chloride | No Ligand | NT | NC | Error |
| L* values | 0 ppm | 78.8 | 77.9 | 77.8 | 0.52 |
| | 0.3 ppm | 79.1 | 78.2 | 77.5 | |
| | 3.0 ppm | 78.9 | 77.9 | 77.6 | |
| | 30 ppm | 79.7 | 78.8 | 78.3 | |
| a* values | 0 ppm | 3.7 | 5.8 | 6.1^{ab} | 0.41 |
| | 0.3 ppm | 3.7 | 5.8 | 5.7^{b} | |
| | 3.0 ppm | 3.9 | 6.4 | 6.2^{a} | |
| | 30 ppm | 3.7 | 6.3 | 6.9^{a} | |
| b* values | 0 ppm | 8.2 | 5.9 | 6.0^{b} | 0.29 |
| | 0.3 ppm | 8.2 | 5.9 | 5.8^{b} | |
| | 3.0 ppm | 8.6 | 6.0 | 6.0^{b} | |
| | 30 ppm | 8.6 | 6.1 | 6.7^{a} | |
| Nitrosyl- | 0 ppm | 1.21 | 1.45^{ab} | — | 0.013 |
| Hemochrome^{c} | 0.3 ppm | 1.22 | 1.43^{b} | — | |
| | 3.0 ppm | 1.21 | 1.46^{a} | — | |
| | 30 ppm | 1.21 | 1.44^{ab} | — | |
| Nicotinamide | 0 ppm | 1.04 | — | 1.14 | 0.015 |
| hemochrome^{d} | 0.3 ppm | 1.04 | — | 1.14 | |
| | 3.0 ppm | 1.04 | — | 1.15 | |
| | 30 ppm | 1.03 | — | 1.15 | |
| pH | 0 ppm | 6.34 | 6.35 | 6.37 | 0.020 |
| | 0.3 ppm | 6.35 | 6.38 | 6.38 | |
| | 3.0 ppm | 6.35 | 6.35 | 6.38 | |
| | 30 ppm | 6.35 | 6.34 | 6.37 | |
| Yield, % | 0 ppm | 94.0 | 90.2 | 97.0^{a} | 1.5 |
| | 0.3 ppm | 93.0 | 91.4 | 96.0^{a} | |
| | 3.0 ppm | 92.7 | 89.5 | 94.7^{ab} | |
| | 30 ppm | 90.9 | 88.8 | 92.6^{b} | |

^{a-b}Means in the same column and trait with different superscript letters differ (p < 0.05).
^{c}Nitrosylhemochrome; percent reflectance 650 nm/percent reflectance 570 nm (greater values indicate higher concentrations of nitrosylhemochrome).
^{d}Nicotinamide hemochrome; percent reflectance 537 nm/percent reflectance 553 nm (greater values indicate higher concentrations of nicotinamide hemochrome).

TABLE 10
Ferric iron chloride effects on mean CIE L*, a*, b* values,
nitrosylhemochrome, nicotinamide hemochrome, pH, and
percent cooking yields of cooked ground turkey
formulated with different pink-color-inducing ligands (no
ligand, 10 ppm sodium nitrite; NT, 1% nicotinamide, NC).

| | Ferric iron | | | | Standard |
|---|---|---|---|---|---|
| Trait | Chloride | No Ligand | NT | NC | Error |
| L* values | 0 ppm | 77.4^{c} | 77.7^{b} | 77.2 | 0.47 |
| | 0.3 ppm | 78.7^{b} | 78.3^{a} | 76.8 | |
| | 3.0 ppm | 80.3^{a} | 78.4^{a} | 77.5 | |
| | 30 ppm | 80.7^{a} | 79.1^{a} | 76.9 | |
| a* values | 0 ppm | 3.4^{b} | 5.7 | 6.5 | 0.42 |
| | 0.3 ppm | 3.4^{b} | 5.8 | 6.2 | |
| | 3.0 ppm | 4.3^{a} | 6.0 | 7.0 | |
| | 30 ppm | 4.3^{a} | 6.4 | 6.7 | |
| b* values | 0 ppm | 8.3^{b} | 5.7^{b} | 5.3 | 0.29 |
| | 0.3 ppm | 8.0^{b} | 5.9^{b} | 5.3 | |
| | 3.0 ppm | 8.9^{a} | 6.1^{b} | 5.5 | |
| | 30 ppm | 9.3^{a} | 6.9^{a} | 5.7 | |
| Nitrosyl- | 0 ppm | 1.21 | 1.44 | — | 0.012 |
| Hemochrome^{c} | 0.3 ppm | 1.20 | 1.43 | — | |
| | 3.0 ppm | 1.21 | 1.43 | — | |
| | 30 ppm | 1.22 | 1.44 | — | |
| Nicotinamide | 0 ppm | 1.03 | | 1.15 | 0.016 |
| hemochrome^{d} | 0.3 ppm | 1.04 | | 1.15 | |
| | 3.0 ppm | 1.04 | | 1.16 | |
| | 30 ppm | 1.03 | | 1.16 | |
| pH | 0 ppm | 6.38^{a} | 6.37 | 6.39 | 0.012 |
| | 0.3 ppm | 6.36^{ab} | 6.36 | 6.40 | |
| | 3.0 ppm | 6.35^{b} | 6.36 | 6.40 | |
| | 30 ppm | 6.34^{b} | 6.35 | 6.40 | |
| Yield, % | 0 ppm | 94.0^{a} | 93.8^{a} | 91.5 | 1.5 |
| | 0.3 ppm | 93.1^{a} | 90.8^{ab} | 94.8 | |
| | 3.0 ppm | 89.1^{b} | 91.2^{ab} | 93.9 | |
| | 30 ppm | 86.5^{b} | 88.9^{b} | 94.7 | |

^{a-b}Means in the same column and trait with different superscript letters differ (p < 0.05).
^{c}Nitrosylhemochrome; percent reflectance 650 nm/percent reflectance 570 nm (greater values indicate higher concentrations of nitrosylhemochrome).
^{d}Nicotinamide hemochrome; percent reflectance 537 nm/percent reflectance 553 nm (greater values indicate higher concentrations of nicotinamide hemochrome).

TABLE 11
Calcium chloride effects on mean CIE L*, a*, b* values,
nitrosylhemochrome, nicotinamide hemochrome, pH, and percent
cooking yields of cooked ground turkey formulated with different
pink-color-inducing ligands (no ligand, 10 ppm sodium nitrite;
NT, 1% nicotinamide, NC).

| | Calcium | | | | Standard |
|---|---|---|---|---|---|
| Trait | Chloride | No Ligand | NT | NC | Error |
| L* values | 0 ppm | 76.6 | 75.7^{b} | 74.9^{c} | 0.33 |
| | 160 ppm | 76.6 | 75.4^{b} | 75.7^{b} | |
| | 320 ppm | 76.5 | 76.1^{ab} | 76.8^{a} | |
| | 480 ppm | 76.7 | 76.5^{a} | 76.5^{a} | |
| a* values | 0 ppm | 4.2^{a} | 6.2^{a} | 7.1^{a} | 0.45 |
| | 160 ppm | 3.6^{ab} | 5.7^{ab} | 5.4^{b} | |
| | 320 ppm | 3.2^{b} | 5.2^{bc} | 3.4^{c} | |
| | 480 ppm | 3.3^{b} | 4.5^{c} | 3.5^{c} | |
| b* values | 0 ppm | 7.3 | 5.2^{b} | 5.0^{b} | 0.36 |
| | 160 ppm | 7.1 | 5.1^{b} | 5.5^{b} | |
| | 320 ppm | 7.5 | 5.7^{ab} | 7.2^{a} | |
| | 480 ppm | 7.7 | 6.4^{a} | 7.3^{a} | |
| Nitrosyl- | 0 ppm | 1.21 | 1.46^{a} | — | 0.023 |
| hemochrome^{d} | 160 ppm | 1.20 | 1.42^{ab} | — | |
| | 320 ppm | 1.19 | 1.38^{b} | — | |
| | 480 ppm | 1.19 | 1.31^{c} | — | |
| Nicotinamide | 0 ppm | 1.04 | — | 1.16^{a} | 0.012 |
| hemochrome^{e} | 160 ppm | 1.04 | — | 1.11^{b} | |
| | 320 ppm | 1.03 | — | 1.06^{c} | |
| | 480 ppm | 1.03 | — | 1.05^{c} | |
| pH | 0 ppm | 6.36 | 6.37 | 6.38^{a} | 0.013 |
| | 160 ppm | 6.36 | 6.35 | 6.39^{a} | |
| | 320 ppm | 6.36 | 6.35 | 6.35^{b} | |
| | 480 ppm | 6.35 | 6.35 | 6.32^{b} | |
| Yield, % | 0 ppm | 92.1 | 91.9 | 94.0 | 1.1 |
| | 160 ppm | 92.8 | 93.3 | 94.5 | |
| | 320 ppm | 92.6 | 91.9 | 94.9 | |
| | 480 ppm | 92.1 | 92.7 | 94.1 | |

^{a-c}Means in the same column and trait with different superscript letters differ (p < 0.05).
^{d}Nitrosylhemochrome; percent reflectance 650 nm/percent reflectance 570 nm (greater values indicate higher concentrations of nitrosylhemochrome).
^{e}Nicotinamide hemochrome; percent reflectance 537 nm/percent reflectance 553 nm (greater values indicate higher concentrations of nicotinamide hemochrome).

Calcium chloride was the only mineral that consistently reduced the pink color defect in cooked ground turkey (Table 11). All levels of calcium chloride increased (p<0.05) lightness compared to the control in samples with added NC and 480 ppm increased (p<0.05) lightness in samples with added NT. Calcium chloride at 160 ppm reduced redness compared to the control in samples containing added NC and 320 and 480 ppm reduced redness across all pinking treatments (p<0.05). Yellowness was increased (p<0.05) by 480 ppm calcium chloride in samples with added NT and by 320 and 480 ppm in samples with added NC. Calcium chloride at 320 and 480 ppm reduced nitrosylhemochrome compared to the control in samples with added NT and all levels of calcium chloride reduced nicotinamide hemochrome in samples with added NC (p<0.05). Calcium chloride (320 and 480 ppm) reduced (p<0.05) pH in samples with added NC. The marination or injection of beef steaks with calcium chloride to improve tenderness have resulted in increased surface browning and faster discoloration than samples not exposed to calcium chloride (Kerth and others 1995; Lawrence and others 2003). It was suggested that as molar concentration increases, so does the number of free radical electrons, which provide more catalysts for myoglobin oxidation.

Aside from the minerals tested, WPCs also contain sodium, chloride, phosphate, and citrate. Sodium, chloride, and phosphate were not tested because they are already added to processed meats at much greater concentrations than that which would be incorporated with the addition of WPCs. Citrate has previously been shown to reduce the pink color defect in cooked ground turkey. Therefore, it appears a combination of calcium and citrate in WPCs may be responsible for reduction or prevention of pink cooked color in ground turkey samples. It is also possible that variations of magnesium and ferric iron chloride in WPCs may be responsible for increased redness in cooked turkey sometimes observed with the addition of WPCs (Dobson and Cornforth 1992; Slesinski and others 2000). However color effects of WPCs on cooked turkey cannot be completely attributed to minerals since lactoferrin had effects on color and not all the protein constituents of WPCs were solely tested. It is also possible that interactions of proteins and/or minerals in WPCs rather than individual constituents play a role in decreasing pink cooked color.

Conclusions

Of the major proteins and minerals found in WPCs, calcium chloride is the constituent that consistently reduced pink cooked color in ground turkey. β-lactoglobulin, α-lactalbumin, BSA, lactose, potassium chloride, and ferrous iron chloride did not affect pink cooked color. Lactoferrin had variable effects on cooked color and further research should be conducted to determine whether it might serve as a means to reduce the pink color defect. Increased redness of cooked turkey observed with the addition of some WPCs may be related to high concentrations of magnesium chloride and ferric iron chloride. Since β-lactoglobulin, α-lactalbumin, and lactose are the major constituents of WPCs and had no effects on the pink color defect of turkey, WPCs cannot be suggested as a useful means to prevent the defect. Rather, addition of calcium chloride or dried milk minerals, containing both calcium and citrate, represent a more suitable means to prevent the pink color defect in uncured, cooked ground turkey.

### EXAMPLE II

Calcium Chloride and Tricalcium Phosphate Effects on the Pink Color Defect in Cooked Ground and Intact Turkey Breast

Calcium chloride (250, 500 ppm) was examined for its ability to reduce the pink color defect induced by sodium nitrite (10 ppm) and nicotinamide (1.0%) in cooked ground turkey in the presence and absence of sodium tripolyphosphate (0.25, 0.5%) and sodium citrate (0.5, 1.0%). The ability of tricalcium phosphate (0.1-0.5%) to reduce pink cooked color also was evaluated in ground turkey and both calcium chloride and tricalcium phosphate were tested for their effects on pink cooked color in whole breast muscle. The combination of calcium chloride and sodium tripolyphosphate, not calcium chloride alone, was necessary for a reduction in pink cooked color induced by nicotinamide. Subsequently, in the presence of phosphate, both calcium chloride and sodium citrate reduced pink cooked color and were most effective in combination. Tricalcium phosphate also was capable of reducing pink cooked color in ground turkey, however substituting tricalcium phosphate for sodium tripolyphosphate resulted in lower pH and cooking yields. In this experiment, neither calcium chloride nor tricalcium phosphate was found to reduce pink cooked color in whole turkey breast. Currently, a combination of sodium tripolyphosphate, calcium chloride, and sodium citrate represents the most suitable means for reducing or preventing the pink color defect in uncured ground turkey.

Materials and Methods

Ground Turkey Preparation

Three separate experiments were conducted with ground turkey to examine: 1) effects of calcium chloride (CC) with and without sodium tripolyphosphate (STP); 2) effects of substituting tricalcium phosphate (TCP) for STP; and 3) effects of CC in combination with sodium citrate (SC) on reducing the pink color defect. Fresh, boneless, skinless turkey breasts (pectoralis major) received from a local processor 2 d postmortem were ground though a 9-mm plate (Grinder model 5323, Toledo Chopper, Toledo, Ohio), mixed (Model A120T, Hobart Corporation, Troy, Ohio) for 4 min, vacuum packaged (barrier bag #212-02006, Sealtite, West Bridgewater, Mass.; Supervac GK184/B, Smith Equipment Company, Clifton, N.J.) and stored at −27° C. for 2-4 months. At the time of sample preparation, turkey was thawed for 24-48 h at 2° C., and finely ground twice through a 4.67 mm plate. Three batches were created which received 2% sodium chloride and 1 of 3 pinking treatments (none; 10 ppm sodium nitrite, NT; 1% nicotinamide, NC) in 20% distilled, deionized water based on the meat weight. Both NT (Product #S-2252) and NC (Product #N-3376) were purchased from Sigma-Aldrich Co. (St. Louis, Mo.). The turkey was mixed for 1 min (Model #62509; Hamilton Beach/Proctor-Silex Inc, Washington, N.C.) before being separated into smaller batches of 100 g each to receive different levels of CC (Sigma-Aldrich Co.), STP (Astaris, St. Louis, Mo.), TCP (Suttons Bay Trading Co., Inc., Fort Wayne, Ind.), and SC (A. C. Legg Packing Co., Inc., Birmingham, Ala.) in 10% distilled, deionized water based on the meat weight to give a total of 30% added solution to each sample.

In experiment 1, 9 batches (100 g each) were created to receive 1 of 3 levels of CC (0, 250, 550 ppm) and 1 of 3 levels of STP (0, 0.25, 0.5%). Four batches were created in experiment 2: 0% TCP+0.5% STP, 0.1% TCP+0.4% STP, 0.25% TCP+0.25% STP, and 0.5% TCP+0% STP. In experiment 3, a constant 0.5% STP was added in combination with sodium chloride and the pinking agent before small batch separation. Following that, 9 smaller batches were formulated with 1 of 3 levels of CC (0, 250, 500 ppm) and 1 of 3 levels of SC (0, 0.5, 1.0%). Batches from all experiments were mixed for 1 min and stuffed into 2 conical centrifuge tubes, approximately 50 g each. To remove air pockets from the cooked products, the stuffed raw tubes were centrifuged for 20 min at 2000×g before overnight storage at 2° C. The following day, samples were cooked to 80° C. in a 90° C. water bath (Isotemp 228, Fisher Scientific, Pittsburg, Pa.). Thermocouples attached to a 12-channel thermocouple scanner (Model #92000-00, Cole Parmer Instrument Company, Barrington, Ill.) were placed in the center of every six samples to determine when the endpoint cooking temperature was reached. Immediately following cooking, samples were placed in ice for 20 min and then stored overnight at 2° C.

Intact Turkey Breast Preparation

Fifteen boneless, skinless turkey breasts (pectoralis major) received from a local processor 2 d postmortem were cut and standardized to 500 g. Each breast was randomly assigned to 1 of 3 pinking treatments (none, 10 ppm NT, 1% NC) and 1 of 5 calcium treatments (none, 250 ppm CC, 500 ppm CC, 0.25% TCP, 0.5% TCP). All ingredients were dissolved in 150 ml (30% of the meat weight) of distilled, deionized water with 2% sodium chloride and 0.5% STP. An exception to this are samples containing 0.25% TCP and 0.5% TCP, which received 0.25% STP and 0% STP, respectively. Each solution was uniformly injected into the turkey breasts using a 16-gauge needle attached to a 20-mL syringe. Insertions were made with the needle approximately 1-cm apart throughout the entire sample. The needle was completely inserted and solution was injected as the needle was slowly withdrawn. Both the front and back surfaces of the breasts were injected. Samples along with any remaining solution not taken up by the meat were then placed in a barrier bag (#030168; Koch Supplies Inc., Kansas City, Mo.) and vacuum packaged. Samples were tumbled under vacuum for 1 h at 2° C. to increase solution uptake, stored at 2° C. overnight, and tumbled again for 30 min. To determine percent uptake, the breasts were removed from their packages, allowed to drip for 5 s and weighed. They were then repackaged and cooked in water (water temperature at 90° C.; Model KET-12T; Cleveland Steam Cooking Specialists, Toronto, Canada) to an internal temperature of 80° C. Thermocouples were place in the center of each breast to monitor temperature and determine when the endpoint cooking temperature was reached. After cooking, samples were chilled in ice for 20 min and then stored at 2° C. overnight.

Analysis

A chroma meter (CR-300, 1-cm aperture, illuminant C; Minolta Corp., Osaka, Japan) was used to measure CIE L*a*b* values and an ultraviolet/visible scanning spectrophotometer (Model 2101 PC; Shimadzu Inc., Kyoto, Japan) was used to measure reflectance form 400-700 nm with 1-nm increments on freshly cut surfaces of each sample. Both instruments were calibrated with a white plate (L* 97.06, a* −0.14, b* 1.93). Chroma meter and spectrophotometer measurements were taken in duplicate, 1 reading per tube, for each ground turkey sample. Three 1.25 cm slices were cut perpendicular to the longitudinal axis of each intact breast sample from which 6 chroma meter readings were taken and 3 reflectance scans. Nitrosylhemochrome was estimated on samples without a pinking treatment and samples containing added NT using the percent reflectance ratio 650 nm/570 nm (AMSA 1991). Nicotinamide hemochrome was estimated on samples without a pinking treatment and samples containing added NC using the percent reflectance ratio 537 nm/553 nm (Schwarz and others 1998). Percent uptake for intact turkey breasts was determined as: [((sample weight after second tumbling—sample weight before injection)/sample weight before injection)×100]. Percent yield was calculated as: [(cooked sample weight/raw sample weight)×100]. A 5-g cooked turkey sample homogenized in 50 ml distilled, deionized water was used to measure pH with a pH electrode (910600; Thermo Orion, Beverly, Mass.) attached to a pH meter (Accumet AR50; Fisher Scientific, Pittsburgh, Pa.). All ground turkey and intact turkey breast experiments were replicated 3 times. Data for ground turkey experiments were analyzed as split-split-plots where the 3 pinking treatments represented the first split and subsequent smaller batches formulated with CC, STP, TCP, and SC represented the second split. The intact turkey breast experiment was analyzed as a completely randomized design. Proc Mixed of SAS (2000) was used to determine treatment differences and means were separated (p<0.05) by pairwise comparisons using the pdiff option.

Results and Discussion

Calcium Chloride and Sodium Tripolyphosphate

Calcium chloride effects with and without STP on CIE L*a*b* values are given in Table 12. When NT or no pink-color-generating ligand was added to the samples, CC had no effects (p>0.05) on lightness (L* value), redness (a* value), or yellowness (b* value) regardless of STP level. In samples without a pink-color-generating ligand, STP decreased (p<0.05) lightness in the presence of CC except for 0.25% STP with 500 ppm CC. Sodium tripolyphosphate also decreased (p<0.05) yellowness regardless of CC level except for 0.25% STP with 500 ppm CC. Sodium tripolyphosphate consistently reduced (p<0.05) lightness and yellowness compared to the control across CC level in samples with added NT. In samples containing added NC, an interaction between CC and STP was apparent especially in CC's ability to reduce redness. Without STP, 250 and 500 ppm CC had no effects on redness compared to samples not containing CC, however with the addition of 0.25% STP, 500 ppm CC reduced (p<0.05) redness and in the presence of 0.5% STP, both levels of CC reduced (p<0.05) redness. Lightness was reduced (p<0.05) by 500 ppm CC in the absence but not in the presence of STP. Both levels of STP reduced (p<0.05) lightness compared to samples without STP regardless of CC level. In the absence of STP, 500 ppm CC reduced (p<0.05) yellowness but the opposite was true where 500 ppm CC increased (p<0.05) yellowness in the presence of STP. Sodium tripolyphosphate decreased (p<0.05) yellowness with 0 or 250 ppm CC, but the decrease was prevented in the presence of 500 ppm CC.

TABLE 12
Calcium chloride effects with and without sodium tripolyphosphate on mean^{a} CIE
L*, a*, b* values for cooked ground turkey formulated with pink-color-inducing ligands
(none, 10 ppm sodium nitrite; NT, 1% nicotinamide, NC).

| | | | Sodium | Sodium | Sodium |
|---|---|---|---|---|---|
| Added | | Calcium | Tripolyphosphate | Tripolyphosphate | Tripolyphosphate |
| Ligand | Trait | Chloride | 0% | 0.25% | 0.5% |
| None | L* values | 0 ppm | 80.6 | 80.1 | 79.7 |
| | | 250 ppm | 81.6^{x} | 79.8^{y} | 78.8^{y} |
| | | 500 ppm | 80.9^{x} | 80.0^{xy} | 79.7^{y} |
| | a* values | 0 ppm | 4.2 | 4.5 | 5.0 |
| | | 250 ppm | 4.6 | 4.6 | 4.4 |
| | | 500 ppm | 3.8 | 3.8 | 4.3 |
| | b* values | 0 ppm | 9.2^{x} | 8.4^{y} | 8.0^{y} |
| | | 250 ppm | 9.0^{x} | 8.0^{y} | 7.8^{y} |
| | | 500 ppm | 8.9^{x} | 8.5^{x} | 7.9^{y} |
| NT | L* values | 0 ppm | 80.5^{x} | 79.2^{y} | 77.8^{z} |
| | | 250 ppm | 80.7^{x} | 79.1^{y} | 78.2^{y} |
| | | 500 ppm | 80.4^{x} | 78.3^{y} | 78.8^{y} |
| | a* values | 0 ppm | 6.3 | 6.3 | 6.0 |
| | | 250 ppm | 6.3 | 6.2 | 6.1 |
| | | 500 ppm | 6.3 | 5.9 | 5.6 |
| | b* values | 0 ppm | 6.8^{x} | 6.1^{y} | 5.5^{z} |
| | | 250 ppm | 6.9^{x} | 5.9^{y} | 5.4^{y} |
| | | 500 ppm | 6.7^{x} | 5.9^{y} | 5.8^{y} |
| NC | L* values | 0 ppm | 81.1^{bx} | 78.2^{y} | 77.6^{y} |
| | | 250 ppm | 79.9^{bcx} | 77.5^{y} | 78.0^{y} |
| | | 500 ppm | 79.4^{cx} | 77.9^{y} | 78.3^{y} |
| | a* values | 0 ppm | 8.1 | 7.6^{b} | 7.9^{b} |
| | | 250 ppm | 8.1^{x} | 7.3^{bx} | 5.5^{cy} |
| | | 500 ppm | 8.1^{x} | 5.0^{cy} | 5.0^{cy} |
| | b* values | 0 ppm | 7.1^{bx} | 5.4^{cy} | 5.3^{cy} |
| | | 250 ppm | 6.7^{bcx} | 5.7^{cy} | 6.1^{by} |
| | | 500 ppm | 6.4^{cxy} | 6.5^{bx} | 5.9^{by} |

^{a}Standard error L* values = 0.50; a* values = 0.37; b* values = 0.28. 3-way interactions (pink-color-inducing ligand × calcium chloride × sodium tripolyphosphate) for L*, a*, and b* values (p < 0.05).
^{b-c}Means within a trait and column with a different superscript letter differ (p < 0.05).
^{x-z}Means within a row with a different superscript letter differ (p < 0.05).

The ability of CC to reduce nitrosylhemochrome and nicotinamide hemochrome was reliant on the presence of STP (Table 13). Without the addition of NT or NC both CC and STP had no effects (p>0.05) on pigment concentrations. However, when samples contained added NT, 500 ppm CC reduced (p<0.05) nitrosylhemochrome only in the presence of STP. Similarly, in samples with added NC, 500 ppm CC required at least 0.25% STP to reduce (p<0.05) nicotinamide hemochrome, whereas 250 ppm CC required 0.5% STP to reduce (p<0.05) nicotinamide hemochrome. Both levels of STP (without CC) increased (p<0.05) nicotinamide hemochrome compared to the control. This increase of nicotinamide hemochrome is likely in direct relation to increased (p<0.05) pH (Table 13) by STP, as higher pH values promote formation of hemochromes (Trout 1989). Calcium chloride (500 ppm) reduced (p<0.05) pH across STP level Not surprisingly, cooking yields were consistently increased (p<0.05) by STP as STP increases charge repulsion between proteins therefore increasing water-holding capacity (Claus and others 1994). Calcium chloride also increased cooking yields with 0 or 0.25% STP.

TABLE 13
Calcium chloride effects with and without sodium tripolyphosphate on mean^{a}
nitrosylhemochrome and nicotinamide hemochrome estimates, pH, and percent cooking
yields for cooked ground turkey formulated with pink-color-inducing ligands (none, 10 ppm
sodium nitrite; NT, 1% nicotinamide; NC).

| | | | Sodium | Sodium | Sodium |
|---|---|---|---|---|---|
| Added | | Calcium | Tripolyphosphate | Tripolyphosphate | Tripolyphosphate |
| Ligand | Trait | Chloride | 0% | 0.25% | 0.5% |
| None | Nitrosylhemochrome^{d} | 0 ppm | 1.22 | 1.22 | 1.23 |
| | | 250 ppm | 1.22 | 1.22 | 1.22 |
| | | 500 ppm | 1.22 | 1.20 | 1.21 |
| | Nicotinamide^{e} | 0 ppm | 1.04 | 1.05 | 1.06 |
| | Hemochrome | 250 ppm | 1.04 | 1.05 | 1.05 |
| | | 500 ppm | 1.03 | 1.04 | 1.05 |
| NT | Nitrosylhemochrome | 0 ppm | 1.43 | 1.43^{b} | 1.44^{b} |
| | | 250 ppm | 1.43 | 1.43^{b} | 1.42^{bc} |
| | | 500 ppm | 1.41 | 1.39^{c} | 1.39^{c} |
| NC | Nicotinamide | 0 ppm | 1.16^{y} | 1.19^{bx} | 1.20^{bx} |
| | Hemochrome | 250 ppm | 1.17^{x} | 1.18^{bx} | 1.12^{cy} |
| | | 500 ppm | 1.18^{x} | 1.12^{cx} | 1.13^{cy} |
| Across | pH | 0 ppm | 6.19^{bz} | 6.32^{by} | 6.41^{bx} |
| All | | 250 ppm | 6.18^{bcz} | 6.31^{bcy} | 6.40^{bcx} |
| | | 500 ppm | 6.17^{cz} | 6.30^{cy} | 6.39^{cx} |
| Across | Yield, % | 0 ppm | 88.2^{cz} | 92.4^{cy} | 94.6^{x} |
| All | | 250 ppm | 88.3^{cz} | 93.4^{bcy} | 95.4^{x} |
| | | 500 ppm | 90.4^{by} | 94.4^{bx} | 96.0^{x} |

^{a}Standard error: Nitrosylhemochrome = 0.012; Nicotinamide hemochrome = 0.013; pH = 0.007; Yield = 0.93. 3-way interaction (pink-color-inducing ligand × calcium chloride × sodium tripolyphosphate) for nicotinamide hemochrome (p < 0.05).
^{b-c}Means in the same column and trait with different superscript letters differ (p < 0.05).
^{d}Nitrosylhemochrome; percent reflectance 650 nm/percent reflectance 570 nm (greater values indicate higher concentrations of nitrosylhemochrome).
^{e}Nicotinamide hemochrome, percent reflectance 537 nm/percent reflectance 553 nm (greater values indicate higher concentrations of nicotinamide hemochrome).
^{x-z}Means within a row with a different superscript letter differ (p < 0.05).

The results of this study indicate that a calcium phosphate complex rather than calcium alone is responsible for reduction or inhibition of the pink color defect in cooked ground turkey. Sodium caseinates are reported to have a lightening effect on processed meats (van den Hoven 1987), and this effect is likely due to the high amounts of colloidal calcium phosphate associated with the casein molecules. Although phosphate is already added to most processed meats, it needs to be considered when using CC as a means to lessen the defect. Therefore the next study was conducted to investigate whether TCP could reduce the defect while still providing the functional characteristics e.g. water holding capacity of STP.

Tricalcium Phosphate and Sodium Tripolyphosphate

The effects of substituting TCP for STP on color traits, pH and cooking yields are given in Table 14. Lightness was progressively increased (p<0.05) by the substitution of STP with TCP across all pinking treatments. The greatest increase in lightness was seen when STP was completely replaced by TCP. In samples with added NC and without a pink-color-generating ligand, all TCP substitutions and complete replacement of STP with TCP resulted in reduced (p<0.05) redness compared to samples with only 0.5% STP except the combination of 0.1% TCP and 0.4% STP when NC was not added to the samples. As the level of TCP increased and STP decreased, yellowness increased with samples containing 0.5% TCP being significantly more yellow than samples containing 0.5% STP across all pinking treatments. Only samples in which STP was completely exchanged for TCP was nitrosylhemochrome reduced (p<0.05) regardless of whether NT was added. It also took a level of 0.5% TCP to reduce (p<0.05) nicotinamide hemochrome compared to samples with 0.5% STP in samples without added NC. However, in samples with added NC, all levels of TCP reduced (p<0.05) nicotinamide hemochrome with 0.5% TCP resulting in the greatest reduction. Samples with all levels of TCP had reduced (p<0.05) pH compared to samples containing 0.5% STP across pinking treatment except samples containing 0.1% TCP and 0.4% STP and added NC. Levels of 0.25% TCP and higher also reduced (p<0.05) cooking yields compared to samples containing only STP across pinking treatment except the combination of 0.25% TCP and 0.25% STP in NC containing samples.

TABLE 14
Effects of substituting tricalcium phosphate (TCP) for sodium tripolyphosphate
(STP) on mean CIE L*, a*, b* values, nitrosylhemochrome, nicotinamide hemochrome,
pH, and percent cooking yields for cooked ground turkey formulated with
pink-color-inducing ligands (none, 10 ppm sodium nitrite, NT, 1% nicotinamide, NC).

| | | | Pink- | Pink- | Pink- | |
|---|---|---|---|---|---|---|
| | | | Color- | Color- | Color- | |
| | | | Inducing | Inducing | Inducing | |
| | | | Ligand | Ligand | Ligand | |
| Trait | TCP | STP | None | NT | NC | Standard Error |
| L* values | 0% | 0.5% | 75.6^{c} | 74.6^{c} | 74.1^{d} | 0.26 |
| | 0.1% | 0.4% | 76.1^{b} | 75.2^{d} | 74.7^{c} | |
| | 0.25% | 0.25% | 76.6^{b} | 76.0^{c} | 75.6^{b} | |
| | 0.5% | 0% | 77.7^{a} | 77.3^{a} | 76.8^{a} | |
| a* values | 0% | 0.5% | 5.1^{a} | 6.4 | 8.6^{b} | 0.52 |
| | 0.1% | 0.4% | 4.7^{ab} | 6.4 | 7.4^{c} | |
| | 0.25% | 0.25% | 4.0^{b} | 6.2 | 5.1^{d} | |
| | 0.5% | 0% | 3.9^{b} | 5.7 | 4.4^{d} | |
| b* values | 0% | 0.5% | 6.6^{b} | 4.7^{b} | 3.9^{d} | 0.32 |
| | 0.1% | 0.4% | 7.1^{b} | 4.9^{b} | 5.0^{c} | |
| | 0.25% | 0.25% | 7.7^{a} | 5.2^{b} | 6.6^{b} | |
| | 0.5% | 0% | 8.3^{a} | 6.4^{a} | 7.9^{a} | |
| Nitrosyl- | 0% | 0.5% | 1.23^{a} | 1.44^{a} | — | 0.015 |
| Hemochrome^{e} | 0.1% | 0.4% | 1.21^{ab} | 1.43^{a} | — | |
| | 0.25% | 0.25% | 1.21^{ab} | 1.44^{a} | — | |
| | 0.5% | 0% | 1.19^{b} | 1.37^{b} | — | |
| Nicotinamide^{f} | 0% | 0.5% | 1.06^{a} | — | 1.21^{a} | 0.015 |
| hemochrome | 0.1% | 0.4% | 1.05^{ab} | — | 1.17^{b} | |
| | 0.25% | 0.25% | 1.03^{ab} | — | 1.10^{c} | |
| | 0.5% | 0% | 1.02^{b} | — | 1.06^{d} | |
| pH | 0% | 0.5% | 6.35^{a} | 6.37^{a} | 6.34^{a} | 0.015 |
| | 0.1% | 0.4% | 6.32^{b} | 6.32^{b} | 6.32^{a} | |
| | 0.25% | 0.25% | 6.26^{c} | 6.27^{c} | 6.27^{b} | |
| | 0.5% | 0% | 6.11^{d} | 6.10^{d} | 6.10^{c} | |
| Yield, % | 0% | 0.5% | 91.5^{a} | 92.7^{a} | 94.4^{a} | 1.3 |
| | 0.1% | 0.4% | 90.7^{ab} | 91.1^{ab} | 94.1^{a} | |
| | 0.25% | 0.25% | 88.0^{bc} | 89.8^{b} | 93.4^{a} | |
| | 0.5% | 0% | 86.5^{c} | 88.4^{b} | 39.4^{b} | |

^{a-d}Means in the same column and trait with different superscript letters differ (p < 0.05).
^{e}Nitrosylhemochrome; percent reflectance 650 nm/percent reflectance 570 nm (greater values indicate higher concentrations of nitrosylhemochrome).
^{f}Nicotinamide hemochrome; percent reflectance 537 nm/percent reflectance 553 nm (greater values indicate higher concentrations of nicotinamide hemochrome).

The effects of adding TCP to ground turkey are similar to the effects of adding citric acid (Kieffer and others 2000) where both reduce the pink color defect but at the same time reduce pH and cooking yields. A level of 0.25% TCP was required to get a reduction in redness in samples with added NC and no pink-color-generating ligand. However, this reduction came with approximately a 3% reduction in cooking yields and this will likely deter processors from using TCP as a means to reduce the pink color defect in turkey.

Calcium Chloride and Sodium Citrate

The influence of CC and SC alone and in combination on CIE L* a* b* values are presented in Table 15. When no pink-color-generating ligand was added to the samples, 500 ppm CC reduced (p<0.05) redness and increased (p<0.05) yellowness compared to samples not containing CC regardless of SC level. Sodium citrate had no effects on redness and yellowness, and both SC and CC had no effects on lightness, when NT or NC was not added to the samples (p>0.05). In samples containing added NT, CC and SC had no effects on CIE L* a* b* values, except 250 ppm CC increased (p<0.05) lightness in the presence of 0.5% SC. Lightness was increased by 500 ppm CC in the absence of SC and 250 ppm CC increased lightness in the presence of 0.5% SC in samples with added NC (p<0.05). Nicotinamide induced redness was reduced (p<0.05) by all levels of CC and SC compared to the control. Similarly, all levels of CC and SC increased (p<0.05) yellowness in NC containing samples, the greatest increase occurring with a combination of CC and SC at either level.

TABLE 15
Calcium chloride effects with and without sodium citrate on
mean^{a} CIE L*, a*, b* values for cooked ground turkey
formulated with pink-color-inducing ligands (none,
10 ppm sodium nitrite; NT, 1% nicotinamide; NC).

| | | | Sodium | Sodium | |
|---|---|---|---|---|---|
| Added | | Calcium | Citrate | Citrate | Sodium Citrate |
| Ligand | Trait | Chloride | 0% | 0.5% | 1.0% |
| None | L* values | 0 ppm | 78.5 | 79.1 | 79.7 |
| | | 250 ppm | 78.5 | 79.1 | 79.2 |
| | | 500 ppm | 77.9 | 79.2 | 79.5 |
| | a* values | 0 ppm | 4.5^{b} | 3.9^{b} | 4.2^{b} |
| | | 250 ppm | 4.1^{b} | 3.5^{bc} | 3.8^{bc} |
| | | 500 ppm | 2.8^{c} | 3.0^{c} | 3.2^{c} |
| | b* values | 0 ppm | 7.7^{c} | 7.6^{c} | 7.4^{c} |
| | | 250 ppm | 8.0^{c} | 8.2^{bc} | 8.0^{bc} |
| | | 500 ppm | 8.8^{b} | 8.5^{b} | 8.3^{b} |
| NT | L* values | 0 ppm | 78.3 | 78.0^{c} | 78.7 |
| | | 250 ppm | 78.1 | 79.1^{b} | 78.8 |
| | | 500 ppm | 77.9 | 78.4^{bc} | 78.4 |
| | a* values | 0 ppm | 6.2 | 6.0 | 6.1 |
| | | 250 ppm | 6.0 | 5.9 | 6.0 |
| | | 500 ppm | 6.1 | 5.9 | 5.8 |
| | b* values | 0 ppm | 5.8 | 5.3 | 5.5 |
| | | 250 ppm | 5.7 | 5.7 | 5.5 |
| | | 500 ppm | 5.8 | 5.8 | 5.9 |
| NC | L* values | 0 ppm | 77.2^{c} | 78.4^{c} | 79.1 |
| | | 250 ppm | 77.2^{c} | 79.4^{b} | 79.7 |
| | | 500 ppm | 78.1^{b} | 78.9^{bc} | 79.4 |
| | a* values | 0 ppm | 6.5^{bx} | 4.2^{by} | 2.9^{bz} |
| | | 250 ppm | 4.4^{cx} | 2.2^{cy} | 1.9^{cy} |
| | | 500 ppm | 2.5^{d} | 2.2^{c} | 2.0^{c} |
| | b* values | 0 ppm | 5.5^{dz} | 6.7^{cy} | 7.8^{cx} |
| | | 250 ppm | 6.9^{cy} | 8.2^{bx} | 8.7^{bx} |
| | | 500 ppm | 7.5^{by} | 8.6^{bx} | 8.6^{bx} |

^{a}Standard error: L* values = 0.34; a* values = 0.46; b* values = 0.32. 2-way interaction (calcium chloride × sodium citrate) for a* values (p < 0.05).
^{b-c}Means within a trait and column with a different superscript letter differ (p < 0.05).
^{x-z}Means within a row with a different superscript letter differ (p < 0.05).

Without induced pinking by NT or NC, 500 ppm CC reduced (p<0.05) nitrosylhemochrome and nicotinamide hemochrome compared to the control in samples with 1.0% SC or without SC (Table 16). Neither CC nor SC affected (p>0.05) nitrosylhemochrome when NT was added to the samples. In NC containing samples, both CC and SC reduced (p<0.05) nicotinamide hemochrome with the greatest reduction occurring with a combination of 1.0% SC and either level of CC.

TABLE 16
Calcium chloride effects with and without sodium citrate on mean^{a}
nitrosylhemochrome and nicotinamide hemochrome estimates,
pH, and percent cooking yields for cooked ground turkey
formulated with pink-color-inducing ligands (none, 10 ppm
sodium nitrite; NT, 1% nicotinamide; NC).

| | | | Sodium | Sodium | Sodium |
|---|---|---|---|---|---|
| Added | | Calcium | Citrate | Citrate | Citrate |
| Ligand | Trait | Chloride | 0% | 0.5% | 1.0% |
| None | Nitrosylhemochrome^{e} | 0 ppm | 1.23^{b} | 1.20 | 1.23^{b} |
| | | 250 ppm | 1.22^{b} | 1.19 | 1.21^{bc} |
| | | 500 ppm | 1.18^{c} | 1.19 | 1.19^{c} |
| | Nicotinamide^{f} | 0 ppm | 1.05^{b} | 1.05 | 1.06^{b} |
| | Hemochrome | 250 ppm | 1.04^{bc} | 1.04 | 1.05^{bc} |
| | | 500 ppm | 1.02^{c} | 1.04 | 1.03^{c} |
| NT | Nitrosylhemochrome | 0 ppm | 1.44 | 1.44 | 1.43 |
| | | 250 ppm | 1.44 | 1.44 | 1.44 |
| | | 500 ppm | 1.45 | 1.44 | 1.42 |
| NC | Nicotinamide | 0 ppm | 1.16^{bx} | 1.08^{by} | 1.04^{bz} |
| | Hemochrome | 250 ppm | 1.08^{cx} | 1.02^{cy} | 1.00^{cy} |
| | | 500 ppm | 1.04^{dx} | 1.02^{cxy} | 1.00^{cy} |
| Across | pH | 0 ppm | 6.36^{bx} | 6.34^{bx} | 6.30^{by} |
| All | | 250 ppm | 6.32^{cx} | 6.27^{cy} | 6.25^{cy} |
| | | 500 ppm | 6.33^{cx} | 6.28^{cy} | 6.29^{by} |
| Across | Yield | 0 ppm | 94.9^{xy} | 95.9^{x} | 94.2^{cy} |
| All | | 250 ppm | 94.7^{y} | 95.5^{xy} | 96.1^{bx} |
| | | 500 ppm | 95.7 | 95.8 | 95.3^{bc} |

^{a}Standard error: Nitrosylhemochrome = 0.017; Nicotinamide hemochrome = 0.014; pH = 0.013; Yield = 0.63. 2-way interaction (calcium chloride × sodium citrate) for nicotinamide hemochrome (p < 0.05).
^{b-d}Means in the same column and trait with different superscript letters differ (p < 0.05).
^{e}Nitrosylhemochrome; percent reflectance 650 nm/percent reflectance 570 nm (greater values indicate higher concentrations of nitrosylhemochrome).
^{f}Nicotinamide hemochrome; percent reflectance 537 nm/percent reflectance 553 nm (greater values indicate higher concentrations of nicotinamide hemochrome).
^{x-z}Means within a row with a different superscript letter differ (p < 0.05).

All levels of CC and SC reduced (p<0.05) pH compared to samples containing neither CC nor SC except 0.5% SC in the absence of CC (Table 16). The small differences in pH due to CC and SC did not (p>0.05) negatively impact cooking yields. The results from this study indicate that CC is more effective than SC at reducing the pink color defect. However, in samples induced pink with NC, a combination of CC and SC resulted in further reductions in pink cooked color than those of CC and SC alone.

Calcium Chloride and Tricalcium Phosphate in Whole Breast Muscle

Both CC and TCP reduced the pink color defect in ground turkey therefore they were tested for their capability to also reduce the pink color defect in whole turkey breast. The effects of CC and TCP on color traits are presented in Table 17. Lightness was unaffected (p>0.05) by all levels of CC and TCP across pinking treatment, except 0.5% TCP, which increased (p<0.05) lightness in the absences of added NT and NC. Both CC and TCP did not decrease redness, and 250 ppm CC even increased (p<0.05) redness compared to samples containing 0 ppm CC when NC was added to induce pinking. Calcium chloride decreased (p<0.05) yellowness compared to the control whereas TCP had no effects on yellowness. Neither CC nor TCP were capable of reducing nitrosylhemochrome or nicotinamide hemochrome and the lower concentrations of CC and TCP actually increased (p<0.05) nicotinamide hemochrome in samples with added NC. Only 0.5% TCP reduced (p<0.05) pH and solution uptake and neither CC nor TCP impacted cooking yields (Table 18). It is unfortunate that neither CC nor TCP were capable of reducing the pink color defect in whole turkey breast. These results are similar to those of citric acid and SC, which similarly are capable of reducing pink cooked color in ground but not intact turkey breast. Therefore inhibition of the pink color defect by CC and TCP is reliant on destruction of cell integrity through the grinding and mixing process. It appears that a calcium phosphate complex is responsible for minimizing pink cooked color in ground turkey. Such a complex may not have been able to enter the myofibers of intact muscle but may have done so in ground muscle since cell membranes were disrupted.

TABLE 17
Calcium chloride (CC) and tricalcium phosphate (TCP) effects
on mean CIE L*, a*, b* values and nitrosylhemochrome and nicotinamide
hemochrome estimates for cooked whole turkey breast formulated with
pink-color-inducing ligands (none, 10 ppm sodium nitrite;
NT, 1% nicotinamide, NC).

| | | | | | Standard |
|---|---|---|---|---|---|
| Trait | CC or TCP | No Ligand | NT | NC | Error |
| L* values | 0 ppm | 77.4^{c} | 77.0^{bc} | 77.3^{bc} | 1.3 |
| | CC or TCP | | | | |
| | 250 ppm CC | 79.3^{cb} | 77.5^{bc} | 75.3^{c} | |
| | 500 ppm CC | 78.3^{cb} | 76.8^{c} | 78.7^{b} | |
| | 0.25% TCP | 78.2^{cb} | 79.6^{b} | 77.0^{bc} | |
| | 0.5% TCP | 80.3^{b} | 78.8^{bc} | 78.6^{b} | |
| a* values | 0 ppm | 5.9 | 7.4 | 10.3^{c} | 1.0 |
| | CC or TCP | | | | |
| | 250 ppm CC | 4.9 | 7.5 | 12.9^{b} | |
| | 500 ppm CC | 6.6 | 7.9 | 9.6^{c} | |
| | 0.25% TCP | 6.6 | 6.7 | 11.4^{c} | |
| | 0.5% TCP | 4.9 | 7.1 | 10.7^{c} | |
| b* values | 0 ppm | 9.0^{b} | 6.5 | 5.2 | 0.45 |
| | CC or TCP | | | | |
| | 250 ppm CC | 7.4^{d} | 6.5 | 5.3 | |
| | 500 ppm CC | 7.9^{cd} | 5.8 | 4.7 | |
| | 0.25% TCP | 8.6^{bc} | 6.5 | 5.3 | |
| | 0.5% TCP | 8.1^{bcd} | 6.3 | 5.2 | |
| Nitrosyl- | 0 ppm | 1.27 | 1.52^{ab} | — | 0.052 |
| Hemochrome^{e} | CC or TCP | | | | |
| | 250 ppm CC | 1.21 | 1.50^{ab} | — | |
| | 500 ppm CC | 1.25 | 1.56^{a} | — | |
| | 0.25% TCP | 1.26 | 1.45^{b} | — | |
| | 0.5% TCP | 1.21 | 1.45^{b} | — | |
| Nicotinamide^{f} | 0 ppm | 1.07 | — | 1.27^{c} | 0.021 |
| hemochrome | CC or TCP | | | | |
| | 250 ppm CC | 1.07 | — | 1.32^{b} | |
| | 500 ppm CC | 1.07 | — | 1.24^{c} | |
| | 0.25% TCP | 1.06 | — | 1.28^{b} | |
| | 0.5% TCP | 1.05 | — | 1.24^{c} | |

^{a-d}Means in the same column and trait with different superscript letters differ (p < 0.05).
^{e}Nitrosylhemochrome; percent reflectance 650 nm/percent reflectance 570 nm (greater values indicate higher concentrations of nitrosylhemochrome).
^{f}Nicotinamide hemochrome; percent reflectance 537 nm/percent reflectance 553 nm (greater values indicate higher concentrations of nicotinamide hemochrome).

TABLE 18
Mean^{a} pH, percent uptake, and percent cooking yields of whole turkey
breast containing calcium chloride (CC) or tricalcium phosphate (TCP)
averaged across pink-color-inducing ligand
(none, 10 ppm sodium nitrite, 1% nicotinamide).

| CC or TCP | pH | Uptake, % | Yield, % |
|---|---|---|---|
| 0 ppm CC or TCP | 6.25^{b} | 23.2^{b} | 74.8 |
| 250 ppm CC | 6.22^{b} | 23.8^{b} | 75.7 |
| 500 ppm CC | 6.25^{b} | 24.6^{b} | 75.2 |
| 0.25% TCP | 6.27^{b} | 24.2^{b} | 74.6 |
| 0.5% TCP | 6.11^{c} | 20.7^{c} | 76.7 |

^{a}Standard error: pH = 0.048; Uptake = 1.3; Yield = 4.3.
^{b-c}Means within a column with a different superscript letter differ (p < 0.05).

Conclusions

A combination of CC and STP, not CC alone, was necessary for effective inhibition of pink cooked color induced by NC in ground turkey. Further, the combination of CC and SC in samples with added STP had the most pronounced effect on pink cooked color induced by NC. Incorporation of CC into ground turkey by the substitution of STP with TCP is also an effective means to reduce pink cooked color, but at the same time increased cooking losses. Therefore, as long as STP is routinely added to processed turkey products, the addition of a combination of CC and SC is currently the most powerful means to reduce the pink color defect in cooked uncured ground turkey. CC and TCP were unable to reduce pink cooked color in whole turkey breast and further investigation is necessary to find a means to reduce the occurrence of the pink color defect in whole turkey breast.

### EXAMPLE III

Effects of Calcium Chloride Injection into Intact Turkey on the Pink Color Defect.

Background

Effects of injecting calcium chloride into intact turkey breasts were evaluated. Initial research (discussed above) indicated that calcium chloride did not have a positive effect on controlling the pink color defect in intact turkey. However, this research was limited because the intact turkey was injected using a hypodermic syringe. Such injection is not indicative of commercial processing practices. Accordingly, the effect of injecting calcium chloride into intact turkey breasts was re-evaluated using a commercial pickle injector.

Materials and Methods

Fresh turkey was obtained from Oscar Mayer. The turkey breasts were formulated to contain 2% NaCl and 0.5% STP. To achieve these ingredient levels the turkey was injected (multineedle commercial injection system) at 30% pump. One treatment was formulated without CaCl₂ (None) and another treatment was formulated to contain CaCl₂ (480 ppm, based on the meat weight). Other treatments included sodium nitrite (10 ppm) and nicotinamide (1%) with and without CaCl₂. Twenty pound batches (5-6 breast lobes) were prepared per treatment. Each batch was vacuum tumbled for one hour and then refrigerated overnight before stuffing and heat processing. Each batch was sufficient to filled two stuffed (#8) fibrous casings per treatment. The turkey was heat processed (176 F internal meat temp.) in a commercial smokehouse (Alkar Engineering). The smokehouse schedule used was: stage 1 (1 hr; 130 dry bulb, DB; wet bulb, WB, off), stage 2 (2 hr; 150 DB, 118 WB; smoke on), stage 3 (2 hr; 160 DB, 136 WB), stage (until internal reached; 190 DB, 180 WB). The product was chilled three days before being cut and the color measured. Approximately 35 repeated color determinations were made per treatment on the internal surface of the cooked, chilled product to establish an average color value. Color was measured using a Minolta chroma meter calibrated against a white calibration plate.

Results and Discussions

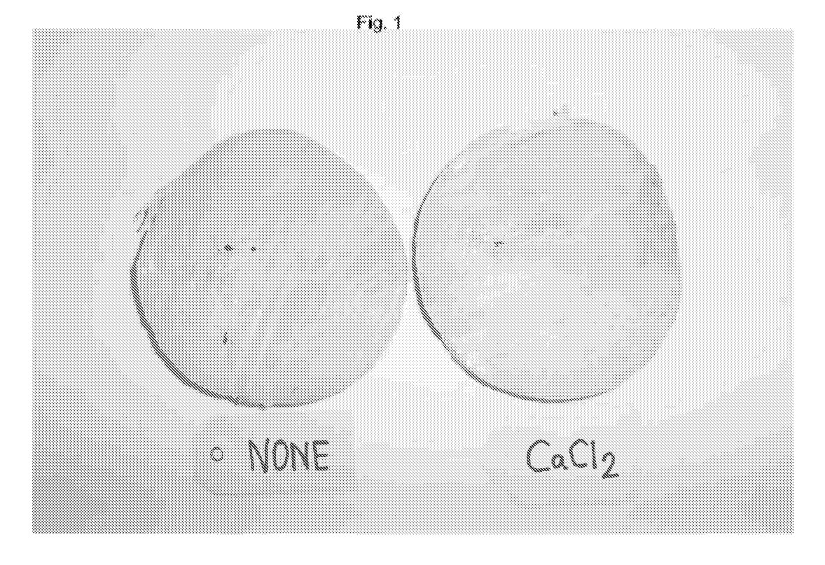

The instrumental measures indicated that the addition of CaCl₂ reduced the redness (CIE a*=5.98) compared to the control samples (none=7.33; without CaCl₂ or any added pinking agent), as shown in FIG. 1. The other treatments tested included samples spiked with nicotinamide (1%) and nitrite (10 ppm). However, with the intact turkey, this level of pink ligand addition was too overwhelmingly high to observe a CaCl₂ effect as the samples were intensely pink beyond what would be observed commercially as turkey with a pink defect. Interestingly, the control (without CaCl₂ or any added pinking agent) did in fact have visible pink. This example illustrates the problem with the pink defect. Despite thoroughly cleaning all equipment prior to use, the defect was present. Other precautions included injecting the control first before any treatments containing a pink generating ligand. Furthermore the product was cooked to an internal temperature of 176 F to denature myoglobin associated with a pink color if not fully heat denatured.

Further, as shown in FIG. 2, in intact control samples of turkey breast and turkey breast samples having citric acid (CA) 0.15% and 0.3% and sodium citrate (SC) 0.5% and 1.0%, which have irradiated at 0 kGy, 2.5 kGy and 5.0 kGy, the control samples that were irradiated were visibly pink whereas samples containing CA and SC were less red and similar in color or lighter than the non-irradiated samples.

Conclusion

Based on this test, it appears that the incorporation of calcium chloride into intact turkey containing polyphosphates has the potential to reduce the pink color defect. Further, samples containing citrate ions has a potential to reduce pink color defect in irradiated samples.

The foregoing description and examples have been set forth merely to illustrate the invention and are not intended to be limiting. Since modifications of the disclosed embodiments incorporating the spirit and substance of the invention may occur to persons skilled in the art, the invention should be construed broadly to include all variations falling within the scope of the appended claims and equivalents thereof. All references cited hereinabove and/or listed below are hereby expressly incorporated by reference.

### III. REFERENCES

(1) Ahn D U, Maurer A J. 1990a. Heme-complex-forming ligands and color of cooked turkey breast meat. Poultry Sci 69:1769-1774.

(2) Ahn D U, Maurer A J. 1990b. Poultry meat color pH and the heme-complex forming reaction. Poultry Sci 69:2020-2050.

(3) AMSA. 1991. Guidelines for meat color evaluation. American Meat Science Association and National Live Stock and Meat Board 44:1-17.

(4) Claus J R, Colby J, Flick G J. 1994. Processed meats/poultry/seafood. In: Kinsman D M, Kotula A W, Breidenstein B C, editors. Muscle Foods. New York: Chapman and Hall. P 106-162.

(5) De Wit J N. 1998. Nutritional and functional characteristics of whey proteins in food products. J Dairy Sci 81:597-608.

(6) Dobson B N, Cornforth D P. 1992. Nonfat dry milk inhibits pink discoloration in turkey rolls. Poultry Sci 71:1943-1946.

(7) Dybling S T, Smith D E. 1991. Relation of chemistry and processing procedures to whey protein functionality: A review. Cultured Dairy Prod J 26:4-12.

(8) Froning G W. 1995. Color of poultry meat. Poultry Avian Biol Rev 6:83-93.

(9) Holownia K, Chinnan M S, Reynolds A E. 2003. Pink color defect in poultry white meat as affected by endogenous conditions. J Food Sci 68:742-747

(10) Imafidon G I, Farkye N Y, Spanier A M. 1997. Isolation, purification, and alteration of some functional groups of major milk proteins: A review. Critical Rev Food Sci Nutr 37:663-689.

(11) Kawakami H, Tanaka M, Tatsumi K, Dosako S. 1992. Effects of ionic strength and pH on the thermostability of lactoferrin. Int Dairy J 2:287-298.

(12) Kerth C R, Miller M F, Ramsey C B. 1995. Improvement of beef tenderness and quality traits with calcium chloride injection in beef loins 48 hours postmortem. J Animal Sci 73:750-756.

(13) Kieffer K J, Claus J R, Wang H. 2000. Inhibition of pink color development in cooked uncured ground turkey by the addition of citric acid. Journal of Muscle Foods 11 (3):235-243.

(14) Knipschildt M E. 1986. Drying of milk and milk products. In: Robinson R K, editor. Modern dairy technology. Volume 1: Advances in milk processing. New York: Elsevier Applied Science Publishers. P131-234.

(15) Lawrence T E, Dikeman M E, Hunt M C, Kastner C L, Johnson D E. 2003. Effects of calcium salts on beef longissimus quality. Meat Sci 63:299-308.

(16) Livingston D J, Brown W D. 1981. The chemistry of myoglobin and its reactions. Food Technol 35:244-252.

(17) Maga J A. 1994. Pink discoloration in cooked white meat. Food Review Int 10:273-286.

(18) Morr C V, Ha E Y W. 1993. Whey protein concentrates and isolates: Processing and functional properties. Crit Rev Food Sci Nutr 33:431-476.

(19) Morr C V, Foegeding E A. 1990. Composition and functionality of commercial whey and milk protein concentrates and isolates: A status report. Food Tech 44:100-112.

(20) Mugler D J, Cunningham F E. 1972. Factors affecting poultry meat color-A review. Worlds Poultry Sci J 28:400-406.

(21) Rongey E H, Bratzler L J. 1966. The effect of various binders and meats on the palatability and processing characteristics of bologna. Food Tech 20:1228-1231.

(22) Sammel L. M., Claus J. R. 2003. Whey protein concentrates effect on pink color development in a cooked ground turkey breast model system. Meat Sci. 65:1293-1299.

(23) Sammel L. M., Claus J. R. 2003. Citric Acid and Sodium Citrate Effects on Reducing Pink Color Defect of Cooked Intact Turkey Breasts and Ground Turkey Rolls. J. Food Sci. 68:874-878.

(24) SAS Institute. 2000. SAS user's guide. North Carolina: SAS Institute, Inc.

(25) Schwarz S J, Claus J R, Wang H, Marriott N G, Graham P P.1998. Quantification of nicotinamide hemochrome in cooked, uncured turkey by reflectance spectrophotometry. J Muscle Foods 9:101-110.

(26) Schwarz S J, Claus J R, Wang H, Marriott N G, Graham P P, Fernandes C F. 1997. Inhibition of pink color development in cooked, uncured ground turkey through the binding of non-pink generating ligands to muscle pigments. Poultry Sci 76:1450-1456.

(27) Schwarz S J, Claus J R, Wang H, Marriott N G, Graham P P, Fernandes C F.1999. Inhibition of Pink Color Development in Cooked, Uncured turkey Breast Through Ingredient Incorporation. Poultry Sci. 78:255-266.

(28) Shimazaki K. 2000. Lactoferrin: A marvelous protein in milk? Anim Sci J 4:329-347.

(29) Slesinski A J, Claus J R, Anderson-Cook C M, Eigel W E, Graham P P, Lenz G E, Noble R B. 2000. Ability of various dairy proteins to reduce pink color development in cooked ground turkey breast. J Food Science 65:417-420.

(30) Tong L M, Sasaki S, McClements D J, Decker E A. 2000. Mechanisms of the antioxidant activity of a high molecular weight fraction of whey. J Agric Food Chem 48:1473-1478.

(31) Trout G R. 1989. Variation in myoglobin denaturation and color of cooked beef, pork, and turkey meat as influenced by pH, sodium chloride, sodium tripolyphosphate, and cooking temperature. J Food Sci 54:536-544.

(32) van den Hoven M. 1987. Functionality of dairy ingredients in meat products. Food Tech 41:72-73, 76-77, 103.Wardman P, Candeias L P. 1996. Fenton chemistry: an introduction. Radiation Research 145:523-531.

What is claimed is:

1. A method of reducing pink color in a cooked light colored meat, comprising the step of contacting an uncooked light colored meat with a compound selected from the group consisting of calcium chloride, tricalcium phosphate, sodium tripolyphosphate, lactoferrin, annatto, and combinations thereof, wherein the pink color is reduced when the uncooked light colored meat is cooked.

2. The method according to claim 1, wherein the uncooked meat is further contacted with sodium citrate.

3. The method according to claim 1, wherein the cooking yield or pH of the cooked meat is substantially unaffected.

4. The method according to claim 1, wherein the uncooked meat contains sodium nitrite or nicotinamide.

5. The method according to claim 1, wherein the uncooked meat is poultry or pork.

6. The method according to claim 1, wherein the uncooked meat is turkey.

7. The method according to claim 6, wherein the uncooked turkey is ground turkey or intact turkey breast.

8. The method according to claim 1, wherein the uncooked meat is contacted with the combination of compounds including calcium, citrate and phosphate ions.

9. The method of claim 1, wherein the uncooked meat is contacted with calcium chloride in the presence of phosphate ions.

10. A method of reducing pink color in a cooked light colored ground or intact meat, comprising the step of contacting an uncooked light colored ground or intact meat with a compound selected from the group consisting of calcium chloride, tricalcium phosphate, sodium tripolyphosphate, lactoferrin, annatto, and combination thereof, wherein the pink color is reduced when the uncooked light colored meat is cooked.

11. The method according to claim 10, wherein the uncooked meat is further contacted with sodium citrate.

12. The method according to claim 10, wherein the cooking yield or pH of the cooked meat is substantially unaffected.

13. The method according to claim 10, wherein the uncooked meat contains sodium nitrite or nicotinamide.

14. The method according to claim 10, wherein the uncooked meat is poultry or pork.

15. The method according to claim 10, wherein the uncooked meat is ground turkey or intact turkey breast.

16. The method according to claim 10, wherein the uncooked meat is contacted with the combination of compounds including calcium, citrate and phosphate ions.

17. The method according to claim 10, wherein the uncooked meat is contacted with calcium chloride in the presence of phosphate ions.

18. A method of reducing pink color in a cooked light colored meat, comprising the steps of:
(i) contacting an uncooked light colored meat with a compound selected from the group consisting of calcium chloride, tricalcium phosphate, sodium tripolyphosphate, lactoferrin, annatto, and combinations thereof;
(ii) irradiating the uncooked light colored meat from step (i); and
(iii) cooking the irradiated uncooked light colored meat from step (ii)
wherein the pink color is reduced when the irradiated uncooked light colored meat is cooked.

19. The method according to claim 18, wherein the uncooked meat is further contacted with sodium citrate in step (i).

20. The method according to claim 18, wherein the uncooked meat is poultry or pork.
